(19) United States
(12) Patent Application Publication
(10) Pub. No.: US 2009/0033218 A1
(43) Pub. Date: Feb. 5, 2009

(54) RED ORGANIC ELECTROLUMINESCENCE ELEMENT

(75) Inventors: Kiyoshi Ikeda, Chiba (JP); Mitsunori Ito, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: IDEMITSU KOSAN CO., LTD., Chiyoda-ku (JP)

(21) Appl. No.: 12/280,475

(22) PCT Filed: Feb. 19, 2007
(86) PCT No.: PCT/JP2007/052957

§ 371 Date: Oct. 1, 2008

(30) Foreign Application Priority Data
Feb. 23, 2006 (JP) 2006-047003

(51) Int. Cl. H01J 1/62

(52) U.S. Cl. 313/504

(57) ABSTRACT

Provided is an organic electroluminescence device in which a single or a plurality of thin organic layers including at least a light emitting layer are sandwiched between an anode and a cathode. At least one of the thin organic layers includes: (A) a perylene compound having at least one halogen atom in its molecule; and (B) a compound having a fused aromatic ring having a ring carbon atoms of 12 to 15. The organic EL device has a high luminous efficiency and a long lifetime and is capable of emitting light having a color range of from an orange color to a red color.

### TECHNICAL FIELD

The present invention relates to an organic electroluminescence (EL) device, in particular, an organic EL device having high luminous efficiency and a long lifetime, and capable of emitting light having a color range of from an orange color to a red color.

### BACKGROUND ART

An organic electroluminescence device is a spontaneous light emitting device which utilizes the principle that a fluorescent substance emits light by energy of recombination of holes injected from an anode and electrons injected from a cathode when an electric field is applied.

Because an organic EL device of the laminate type driven under a low electric voltage was reported by C. W. Tang et al. of Eastman Kodak Company (C. W. Tang and S. A. Vanslyke, Applied Physics Letters, Volume 51, Page 913, 1987, or the like), many studies have been conducted on organic EL devices using organic materials as the constituent materials.

Tang et al. adopted a laminate structure using tris(8-quinolinol)aluminum for a light emitting layer and a triphenyldiamine derivative for a hole transporting layer. Advantages of the laminate structure are that the efficiency of hole injection into the light emitting layer can be increased, that the efficiency of forming exciton which are formed by blocking and recombining electrons injected to the cathode can be increased, and that exciton formed within the light emitting layer can be enclosed. As described above, for the structure of the organic EL device, a two-layered structure having a hole transporting (injecting) layer and an electron-transporting light emitting layer and a three-layered structure having a hole transporting (injecting) layer, a light emitting layer, and an electron-transporting (injecting) layer are well known. In order to increase the efficiency of recombination of injected holes and electrons in the devices of the laminate type structure, the structure of the device and the process for forming the device have been studied.

Further, as the light emitting device to used in an organic EL device, light emitting materials such as chelate complexes such as tris(8-quinolinol)aluminum complexes, coumarine complexes, tetraphenylbutadiene derivatives, bisstyrylarylene derivatives, and oxadiazole derivatives are known. It is reported that light in the visible region ranging from blue light to red light can be obtained by using those light emitting materials, and development of a device exhibiting color images is expected (for example, Patent Documents 1 to 3). However, the luminous efficiency and lifetime thereof at practical levels have not been achieved and are insufficient. In addition, a full-color display is requested to have light emitting devices capable of emitting light beams with three primary colors (blue, green, and red colors); out of the devices, a highly efficient red light emitting device has been demanded.

To cope with such demand, a document recently issued such as Patent Document 4 discloses a device using each of a dicyanoanthracene derivative and an indenoperylene derivative in a light emitting layer, and using a metal complex in an electron transporting layer. However, the luminescent color of light emitted from the device is a reddish orange color. Patent Document 5 discloses a device using each of a naphthacene derivative and an indenoperylene derivative in a light emitting layer, and using a naphthacene derivative in an electron transporting layer. However, the constitution of the device is complicated. Patent Document 6 proposes a light emitting device including a light emission preventing layer having a larger band gap than those of a light emitting layer and an electron transporting layer for suppressing the light emission of the electron transporting layer. However, the light emitting device has insufficient luminous efficiency; the efficiency is about 1 cd/A. Patent Document 7 discloses an organic EL device containing, in one layer, an amine compound containing a perylenyl group and a peryfurantene derivative. However, none of all the examples of the description involves the use of a peryfurantene derivative containing a halogen atom as an essential ingredient, and the description does not describe that the use of such peryfurantene derivative leads to the emission of red light having high luminance and a high color purity.

Patent Document 1: JP 08-239655 A

Patent Document 2: JP 07-138561 A

Patent Document 3: JP 03-200289 A

Patent Document 4: JP 2001-307885 A

Patent Document 5: JP 2003-338377 A

Patent Document 6: JP 2005-235564 A

Patent Document 7: JP 2005-068366 A

### DISCLOSURE OF THE INVENTION

### Problems to be Solved by the Invention

The present invention has been made with a view to solving the above problems, and an object of the present invention is to provide an organic EL device having high luminous efficiency and a long lifetime, and capable of emitting light having a color range of from an orange color to a red color.

### Means for Solving the Problems

The inventors of the present invention have made extensive studies with a view to achieving the above object. As a result, the inventors have found that the above object can be achieved by using a specific perylene compound and a compound having a specific fused aromatic ring in combination in the organic thin film layer of an organic EL device, in particular, a light emitting layer. Thus, the inventors have completed the present invention.

That is, the present invention provides an organic electroluminescence device including an organic thin film layer formed of one or a plurality of layers including at least a light emitting layer, the organic thin film layer being interposed between a cathode and an anode, wherein at least one layer of the organic thin film layer contains (A) a perylene compound having at least one halogen atom in any one of molecules and (B) a compound having a fused aromatic ring having 12 to 50 ring carbon atoms.

### EFFECTS OF THE INVENTION

The organic EL device of the present invention has high luminous efficiency and a long lifetime, and is capable of emitting light having a color range of from an orange color to a red color.

### BEST MODE FOR CARRYING OUT THE INVENTION

An organic EL device of the present invention is an organic electroluminescence device including an organic thin film layer formed of one or a plurality of layers including at least a light emitting layer, the organic thin film layer being interposed between a cathode and an anode, in which at least one layer of the organic thin film layer contains (A) a perylene compound having at least one halogen atom in any one of its molecules and (B) a compound having a fused aromatic ring having 12 to 50 ring carbon atoms.

Hereinafter, the component (A) will be described.

The basic skeleton of the perylene compound as the component (A) is preferably, for example, a structure typified by each of general formulae (1) and (2). The basic skeleton preferably has 45 or more and 100 or less ring carbon atoms. When the number of ring carbon atoms is 45 or more, the compound is excellent in heat resistance. When the number is 100 or less, a vapor pressure at the time of the production of the device never becomes insufficient, and a solution of the compound can be easily prepared, so the compound can be easily formed into a film by an application method.

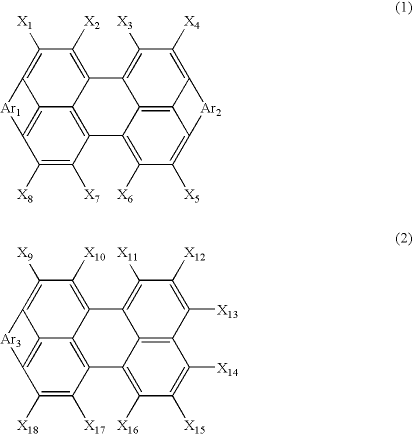

Ar₁, Ar₂, and Ar₃ each independently represent a substituted or unsubstituted aromatic hydrocarbon group having 6 to 50 ring carbon atoms, or a substituted or unsubstituted aromatic heterocyclic group having 6 to 50 ring atoms.

Examples of the aromatic hydrocarbon group include divalent residues of benzene, naphthalene, anthracene, phenanthrene, pyrene, perylene, chrysene, biphenyl, and the like. Of those, a divalent residue of benzene or naphthalene is preferable in terms of the yield in which the component (A) is produced and the reduction of impurities because the component (A) can be produced at a low sublimation temperature in a sublimation step to be typically used at the time of the production of the component (A). In addition, examples of the substituent include groups listed in X₁ to X₁₈ to be described later.

Examples of the aromatic heterocyclic group include divalent residues of pyridine, pyrimidine, pyrazine, pyridazine, triazine, quinoline, quinoxaline, acridine, imidazopyridine, imidazopyrimidine, phenanthroline, indole, pyrroline, furyl, furan, benzofuran, isobenzofuran, carbazole, acridine, phenazine, phenothiazine, phenoxazine, oxazole, oxadiazole, butylpyrrole, phenylpropylpyrrole, methylindol, methylindol, butylindol, and the like. Of those, a divalent residue of pyridine or pyrimidine is preferable in terms of the yield in which the component (A) is produced and the reduction of impurities because the component (A) can be produced at a low sublimation temperature in a sublimation step to be typically used at the time of the production of the component (A). In addition, examples of the substituent include groups similar to those of the aromatic hydrocarbon group.

In the general formulae (1) and (2), X₁ to X₁₈ each independently represent a group selected from a hydrogen atom, a halogen atom, a substituted or unsubstituted alkyl group having 1 to 50 carbon atoms, a substituted or unsubstituted alkoxy group having 1 to 50 carbon atoms, a substituted or unsubstituted alkylthio group having 1 to 50 carbon atoms, a substituted or unsubstituted alkenyl group having 2 to 50 carbon atoms, a substituted or unsubstituted alkenyloxy group having 1 to 50 carbon atoms, a substituted or unsubstituted alkenylthio group having 1 to 50 carbon atoms, a substituted or unsubstituted aromatic hydrocarbon group having 6 to 50 ring carbon atoms, a substituted or unsubstituted aromatic heterocyclic group having 6 to 50 ring atoms, a substituted or unsubstituted aryloxy group having 6 to 50 ring carbon atoms, a substituted or unsubstituted arylthio group having 6 to 50 ring carbon atoms, a substituted or unsubstituted aralkyl group having 7 to 50 ring carbon atoms, a substituted or unsubstituted arylalkyloxy group having 6 to 50 ring carbon atoms, a substituted or unsubstituted arylalkylthio group having 6 to 50 ring carbon atoms, a substituted or unsubstituted arylalkenyl group having 6 to 50 ring carbon atoms, a substituted or unsubstituted alkenylaryl group having 6 to 50 ring carbon atoms, an amino group, a carbazolyl group, a cyano group, a hydroxyl group, —COOR₁, —COR₂, and —OCOR₃ where R₁, R₂, and R₃ each represent a hydrogen atom, a substituted or unsubstituted alkyl group having 1 to 50 carbon atoms, a substituted or unsubstituted alkenyl group having 2 to 50 carbon atoms, a substituted or unsubstituted aralkyl group having 7 to 50 ring carbon atoms, a substituted or unsubstituted aromatic hydrocarbon group having 6 to 50 ring carbon atoms, or a substituted or unsubstituted aromatic heterocyclic group having 6 to 50 ring atoms, adjacent groups of X₁ to X₁₈ may be bonded to each other, and each of X₁ to X₁₈ may form a ring with a carbon atom to which the group is bonded, provided that at least one of substituents of Ar₁, Ar₂, and Ar₃, X₁ to X₁₈, and substituents of X₁ to X₁₈ represents a halogen atom.

Examples of the halogen atom represented by each of X₁ to X₁₈ include a fluorine atom, a chlorine atom, a bromine atom, and an iodine atom.

Examples of the alkyl group represented by each of X₁ to X₁₈ include a methyl group, an ethyl group, a propyl group, an isopropyl group, an n-butyl group, an s-butyl group, an isobutyl group, a t-butyl group, an n-pentyl group, an n-hexyl group, an n-heptyl group, an n-octyl group, a hydroxymethyl group, a 1-hydroxyethyl group, a 2-hydroxyethyl group, a 2-hydroxyisobutyl group, a 1,2-dihydroxyethyl group, a 1,3-dihydroxyisopropyl group, a 2,3-dihydroxy-t-butyl group, a 1,2,3-trihydroxypropyl group, a fluoromethyl group, a trifluoromethyl group, a 1-fluoroethyl group, a 2-fluoroethyl group, a 2-fluoroisobutyl group, a 1,2-difluoroethyl group, a 1,3-difluoroisopropyl group, a 2,3-difluoro-t-buthyl group, a 1,2,3-trifluoropropyl group, a chloromethyl group, a 1-chloroethyl group, a 2-chloroethyl group, a 2-chloroisobutyl group, a 1,2-dichloroethyl group, a 1,3-dichloroisopropyl group, a 2,3-dichloro-t-butyl group, a 1,2,3-trichloropropyl group, a bromomethyl group, a 1-bromoethyl group, a 2-bromoethyl group, a 2-bromoisobutyl group, a 1,2-dibromoethyl group, a 1,3-dibromoisopropyl group, a 2,3-dibromo-t-butyl group, a 1,2,3-tribromopropyl group, an iodomethyl group, a 1-iodoethyl group, a 2-iodoethyl group, a 2-iodoisobutyl group, a 1,2-diiodoethyl group, a 1,3-diiodoisopropyl group, a 2,3-diiodo-t-butyl group, a 1,2,3-triiodopropyl group, an aminomethyl group, a 1-aminoethyl group, a 2-aminoethyl group, a 2-aminoisobutyl group, a 1,2-diaminoethyl group, a 1,3-diaminoisopropyl group, a 2,3-diamino-t-butyl group, a 1,2,3-triaminopropyl group, a cyanomethyl group, a 1-cyanoethyl group, a 2-cyanoethyl group, a 2-cyanoisobutyl group, a 1,2-dicyanoethyl group, a 1,3-dicyanoisopropyl group, a 2,3-dicyano-t-butyl group, a 1,2,3-tricyanopropyl group, a nitromethyl group, a 1-nitroethyl group, a 2-nitroethyl group, a 2-nitroisobutyl group, a 1,2-dinitroethyl group, a 1,3-dinitroisopropyl group, a 2,3-dinitro-t-butyl group, and a 1,2,3-trinitropropyl group.

Of those, a methyl group, an ethyl group, an isopropyl group, a 1-butyl group, a 2-methylpropyl group, a 1,1-dimethylethyl group, a dimethyl group, and a trimethyl group are preferable.

The alkoxy group represented by each of X₁ to X₁₈ is a group represented by —OY′, and examples of Y′ include the same groups as those described with respect to the alkyl group.

The alkylthio group represented by each of X₁ to X₁₈ is a group represented by —SY′, and examples of Y′ include the same groups as those described with respect to the alkyl group.

Examples of the alkenyl group represented by each of X₁ to X₁₈ include a vinyl group, an allyl group, a 1-butenyl group, a 2-butenyl group, a 3-butenyl group, a 1,3-butanedienyl group, a 1-methylvinyl group, a styryl group, a 2,2-diphenylvinyl group, a 1,2-diphenylvinyl group, a 1-methylallyl group, a 1,1-dimethylallyl group, a 2-methylallyl group, a 1-phenylallyl group, a 2-phenylallyl group, a 3-phenylallyl group, a 3,3-diphenylallyl group, a 1,2-dimethylallyl group, a 1-phenyl-1-butenyl group, and a 3-phenyl-1-butenyl group. Of those, a styryl group, a 2,2-diphenylvinyl group, and a 1,2-diphenylvinyl group are preferable.

The alkenyloxy group represented by each of X₁ to X₁₈ is a group represented by —OY″, and examples of Y″ include the same groups as those described with respect to the alkenyl group.

The alkenylthio group represented by each of X₁ to X₁₈ is a group represented by —SY″, and examples of Y″ include the same groups as those described with respect to the alkenyl group.

Examples of the aromatic hydrocarbon group represented by each of X₁ to X₁₈ include a phenyl group, a 1-naphthyl group, a 2-naphthyl group, a 1-anthryl group, a 2-anthryl group, a 9-anthryl group, a 9-(10-phenyl)anthryl group, a 9-(10-naphthyl-1-yl)anthryl group, a 9-(10-naphthyl-2-yl) anthryl group, a 1-phenanthryl group, a 2-phenanthryl group, a 3-phenanthryl group, a 4-phenanthryl group, a 9-phenanthryl group, a 6-chryseny group, a 1-naphthacenyl group, a 2-naphthacenyl group, a 9-naphthacenyl group, a 1-pyrenyl group, a 2-pyrenyl group, a 4-pyrenyl group, a 2-biphenylyl group, a 3-biphenylyl group, a 4-biphenylyl group, a p-terphenyl-4-yl group, a p-terphenyl-3-yl group, a p-terphenyl-2-yl group, an m-terphenyl-4-yl group, an m-terphenyl-3-yl group, an m-terphenyl-2-yl group, an o-tolyl group, an m-tolyl group, a p-tolyl group, a p-t-butylphenyl group, a 3-methyl-2-naphthyl group, a 4-methyl-1-naphthyl group, and a 4-methyl-1-anthryl group.

Examples of the aromatic heterocyclic group represented by each of X₁ to X₁₈ include a 1-pyrrolyl group, a 2-pyrrolyl group, a 3-pyrrolyl group, a pyrazinyl group, a 2-pyridinyl group, a 1-imidazolyl group, a 2-imidazolyl group, a 1-pyrazolyl group, a 1-indolizinyl group, a 2-indolizinyl group, a 3-indolizinyl group, a 5-indolizinyl group, a 6-indolizinyl group, a 7-indolizinyl group, an 8-indolizinyl group, a 2-imidazopyridinyl group, a 3-imidazopyridinyl group, a 5-imidazopyridinyl group, a 6-imidazopyridinyl group, a 7-imidazopyridinyl group, an 8-imidazopyridinyl group, a 3-pyridinyl group, a 4-pyridinyl group, a 1-indolyl group, a 2-indolyl group, a 3-indolyl group, a 4-indolyl group, a 5-indolyl group, a 6-indolyl group, a 7-indolyl group, a 1-isoindolyl group, a 2-isoindolyl group, a 3-isoindolyl group, a 4-isoindolyl group, a 5-isoindolyl group, a 6-isoindolyl group, a 7-isoindolyl group, a 2-furyl group, a 3-furyl group, a 2-benzofuranyl group, a 3-benzofuranyl group, a 4-benzofuranyl group, a 5-benzofuranyl group, a 6-benzofuranyl group, a 7-benzofuranyl group, a 1-isobenzofuranyl group, a 3-isobenzofuranyl group, a 4-isobenzofuranyl group, a 5-isobenzofuranyl group, a 6-isobenzofuranyl group, a 7-isobenzofuranyl group, a 2-quinolyl group, a 3-quinolyl group, a 4-quinolyl group, a 5-quinolyl group, a 6-quinolyl group, a 7-quinolyl group, an 8-quinolyl group, a 1-isoquinolyl group, a 3-isoquinolyl group, a 4-isoquinolyl group, a 5-isoquinolyl group, a 6-isoquinolyl group, a 7-isoquinolyl group, an 8-isoquinolyl group, a 2-quinoxalinyl group, a 5-quinoxalinyl group, a 6-quinoxalinyl group, a 1-carbazolyl group, a 2-carbazolyl group, a 3-carbazolyl group, a 4-carbazolyl group, a 9-carbazolyl group, a β-carboline-1-yl group, a β-carboline-3-yl group, a β-carboline-4-yl group, a β-carboline-5-yl group, a β-carboline-6-yl group, a β-carboline-7-yl group, a β-carboline-6-yl group, a β-carboline-9-yl group, a 1-phenanthridinyl group, a 2-phenanthridinyl group, a 3-phenanthridinyl group, a 4-phenanthridinyl group, a 6-phenanthridinyl group, a 7-phenanthridinyl group, an 8-phenanthridinyl group, a 9-phenanthridinyl group, a 10-phenanthridinyl group, a 1-acridinyl group, a 2-acridinyl group, a 3-acridinyl group, a 4-acridinyl group, a 9-acridinyl group, a 1,7-phenanthroline-2-yl group, a 1,7-phenanthroline-3-yl group a 1,7-phenanthroline-4-yl group, a 1,7-phenanthroline-5-yl group, a 1,7-phenanthroline-6-yl group, a 1,7-phenanthroline-8-yl group, a 1,7-phenanthroline-9-yl group, a 1,7-phenanthroline-10-yl group, a 1,8-phenanthroline-2-yl group, a 1,8-phenanthroline-3-yl group, a 1,8-phenanthroline-4-yl group, a 1,8-phenanthroline-5-yl group, a 1,8-phenanthroline-6-yl group, a 1,8-phenanthroline-7-yl group, a 1,8-phenanthroline-9-yl group, a 1,8-phenanthroline-10-yl group, a 1,9-phenanthroline-2-yl group, a 1,9-phenanthroline-3-yl group, a 1,9-phenanthroline-4-yl group, a 1,9-phenanthroline-5-yl group, a 1,9-phenanthroline-6-yl group, a 1,9-phenanthroline-7-yl group, a 1,9-phenanthroline-8-yl group, a 1,9-phenanthroline-10-yl group, a 1,10-phenanthroline-2-yl group, a 1,10-phenanthroline-3-yl group, a 1,10-phenanthroline-4-yl group, a 1,10-phenanthroline-5-yl group, a 2,9-phenanthroline-1-yl group, a 2,9-phenanthroline-3-yl group, a 2,9-phenanthroline-4-yl group, a 2,9-phenanthroline-5-yl group, a 2,9-phenanthroline-6-yl group, a 2,9-phenanthroline-7-yl group, a 2,9-phenanthroline-8-yl group, a 2,9-phenanthroline-10-yl group, a 2,8-phenanthroline-1-yl group, a 2,8-phenanthroline-3-yl group, a 2,8-phenanthroline-4-yl group, a 2,8-phenanthroline-5-yl group, a 2,8-phenanthroline-6-yl group, a 2,8-phenanthroline-7-yl group, a 2,8-phenanthroline-9-yl group, a 2,8-phenanthroline-10-yl group, a 2,7-phenanthroline-1-yl group, a 2,7-phenanthroline-3-yl group, a 2,7-phenanthroline-4-yl group, a 2,7-phenanthroline-5-yl group, a 2,7-phenanthroline-6-yl group, a 2,7-phenanthroline-8-yl group, a 2,7-phenanthroline-9-yl group, a 2,7-phenanthroline-10-yl group, a 1-phenazinyl group, a 2-phenazinyl group, a 1-phenothiazinyl group, a 2-phenothiazinyl group, a 3-phenothiazinyl group, a 4-phenothiazinyl group, a 10-phenothiazinyl group, a 1-phenoxazinyl group, a 2-phenoxazinyl group, a 3-phenoxazinyl group, a 4-phenoxazinyl group, a 10-phenoxazinyl group, a 2-oxazolyl group, a 4-oxazolyl group, a 5-oxazolyl group, a 2-oxadiazolyl group, a 5-oxadiazolyl group, a 3-furazanyl group, a 2-thienyl group, a 3-thienyl group, a 2-methylpyrrole-1-yl group, a 2-methylpyrrole-3-yl group, a 2-methylpyrrole-4-yl group, a 2-methylpyrrole-5-yl group, a 3-methylpyrrole-1-yl group, a 3-methylpyrrole-2-yl group, a 3-methylpyrrole-4-yl group, a 3-methylpyrrole-5-yl group, a 2-t-butylpyrrol-4-yl group, a 3-(2-phenylpropyl)pyrrol-1-yl group, a 2-methyl-1-indolyl group, a 4-methyl-1-indolyl group, a 2-methyl-3-indolyl group, a 4-methyl-3-indolyl group, a 2-t-butyl-1-indolyl group, a 4-t-butyl-1-indolyl group, a 2-t-butyl-3-indolyl group, and a 4-t-butyl-3-indolyl group.

The aryloxy group represented by any one of X₁ to X₁₈ is a group represented by —OY′″, and examples of Y′″ include examples similar to those described for the aromatic hydrocarbon group and the aromatic heterocyclic group.

The arylthio group represented by any one of X₁ to X₁₈ is a group represented by —SY′″, and examples of Y′″ include examples similar to those described for the aromatic hydrocarbon group and the aromatic heterocyclic group.

Examples of the aralkyl group represented by any one of X₁ to X₁₈ include examples each obtained by substituting the alkyl group by any one of the aromatic hydrocarbon group and the aromatic heterocyclic group. Examples of the arylalkyloxy group represented by any one of X₁ to X₁₈ include examples each obtained by substituting the alkyloxy group by any one of the aromatic hydrocarbon group and the aromatic heterocyclic group. Examples of the arylalkylthio group represented by any one of X₁ to X₁₈ include examples each obtained by substituting the alkylthio group by any one of the aromatic hydrocarbon group and the aromatic heterocyclic group. Examples of the arylalkenyl group represented by any one of X₁ to X₁₈ include examples each obtained by substituting the alkenyl group by any one of the aromatic hydrocarbon group and the aromatic heterocyclic group. Examples of the alkenylaryl group represented by any one of X₁ to X₁₈ include examples each obtained by substituting any one of the aromatic hydrocarbon group and the aromatic heterocyclic group by the alkenyl group.

In addition, examples of each of the groups R₁ to R₃ of —COOR₁, —COR₂, and —OCOR₃ include examples similar to those described above.

Further, examples of a ring which may be formed together with a carbon atom where X₁ to X₁₈ are bound together include: cycloalkanes each having 4 to 12 carbon atoms such as cyclopentane, cyclohexane, adamantane, and norbornane; cycloalkenes each having 4 to 12 carbon atoms such as cyclopentene and cyclohexene; cycloalkadienes each having 4 to 12 carbon atoms such as cyclopentadiene and cyclohexadiene; and aromatic rings each having 6 to 50 carbon atoms such as benzene, naphthalene, phenanthrene, anthracene, pyrene, chrysene, perylene, and acenaphthylene.

In addition, at least one of X₁ to X₁₈ in the general formulae (1) and (2) preferably represents a halogen atom. The perylene compound as the component (A) is preferably a compound containing at least one fluorine atom or trifluoromethyl group because the compound is excellent in stability, and hence contributes to the lengthening of the lifetime of the device.

Ar₁, Ar₂, and Ar₃ in the general formulae (1) and (2) each preferably represent a structure represented by the following general formula (3) or (4).

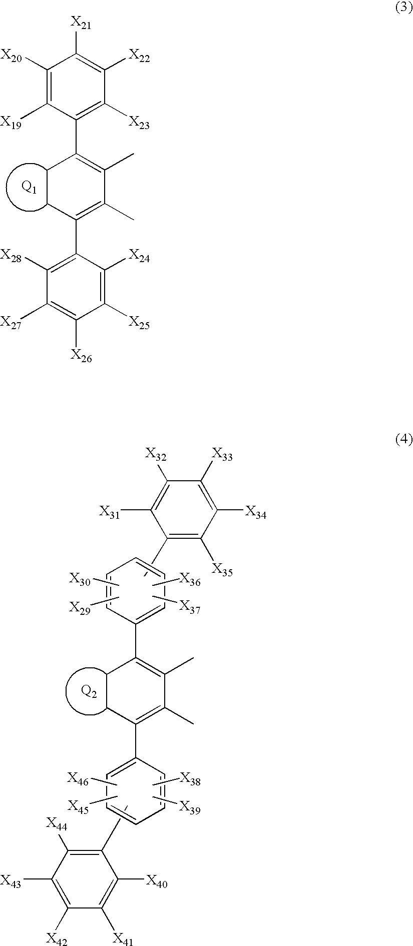

In the general formulae (3) and (4), X₁₉ to X₄₆ each have the same meaning as that of each of X₁ to X₁₈ described above, and specific examples of each of X₁₉ to X₄₆ include examples similar to those of each of X₁ to X₁₈.

In the general formulae (3) and (4), a ring Q₁ and a ring Q₂ each independently represent a substituted or unsubstituted aromatic hydrocarbon ring having 6 to 50 ring carbon atoms, or a substituted or unsubstituted aromatic heterocyclic ring having 6 to 50 ring atoms, and examples of each of the rings include examples similar to those of the aromatic hydrocarbon group and the aromatic heterocyclic group each represented by any one of Ar₁, Ar₂, and Ar₃ described above.

It should be noted that, in the general formula (3), at least one of X₁₉ to X₂₈ represents a fluorine atom or a trifluoromethyl group, and, in the general formula (4), at least one of X₂₉ to X₄₆ represents a fluorine atom or a trifluoromethyl group. This is because, when the compound contains at least one fluorine atom or trifluoromethyl group, the compound is excellent in stability, and hence contributes to the lengthening of the lifetime of the device.

In addition, the perylene compound as the component (A) is preferably of a structure represented by any one of the general formulae (1) and (2), and the following general formulae (a) to (c).

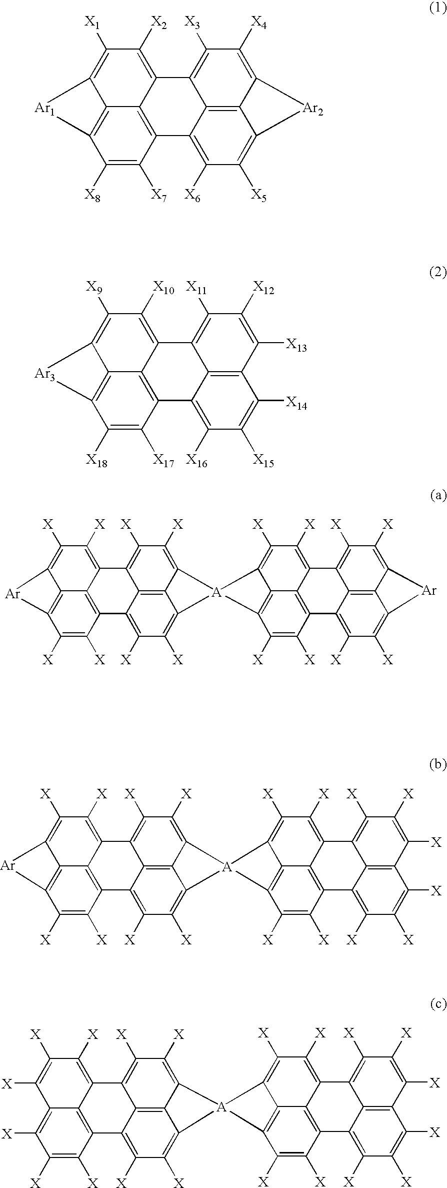

In the general formulae (a) to (c), A and Ar each have the same meaning as that of each of Ar₁ to Ar₃ described above, and specific examples of each of A and Ar include examples similar to those of each of Ar₁ to Ar₃, and X has the same meaning as that of each of X₁ to X₁₈ described above, and specific examples of X include examples similar to those of each of X₁ to X₁₈.

The perylene compound as the component (A) of the present invention is preferably a dibenzotetraphenylperyfurantene derivative. This is because of the following reason: the use of such compound as a component for the light emitting layer may provide the device with additionally high luminous efficiency since the use reduces the frequency at which the device emits light having a wavelength in a region except a visible light region. In this case, the compound is more preferably a compound represented by the general formula (3) or (4) in which at least one of X₁₉ to X₂₈ or of X₂₉ to X₄₆ represents a fluorine atom or a trifluoromethyl group because the compound is excellent in stability, and hence contributes to the lengthening of the lifetime of the device.

Hereinafter, exemplified compounds represented by the general formulae (1) and (2) for the component (A) are shown. However, the present invention is not limited to these compounds.

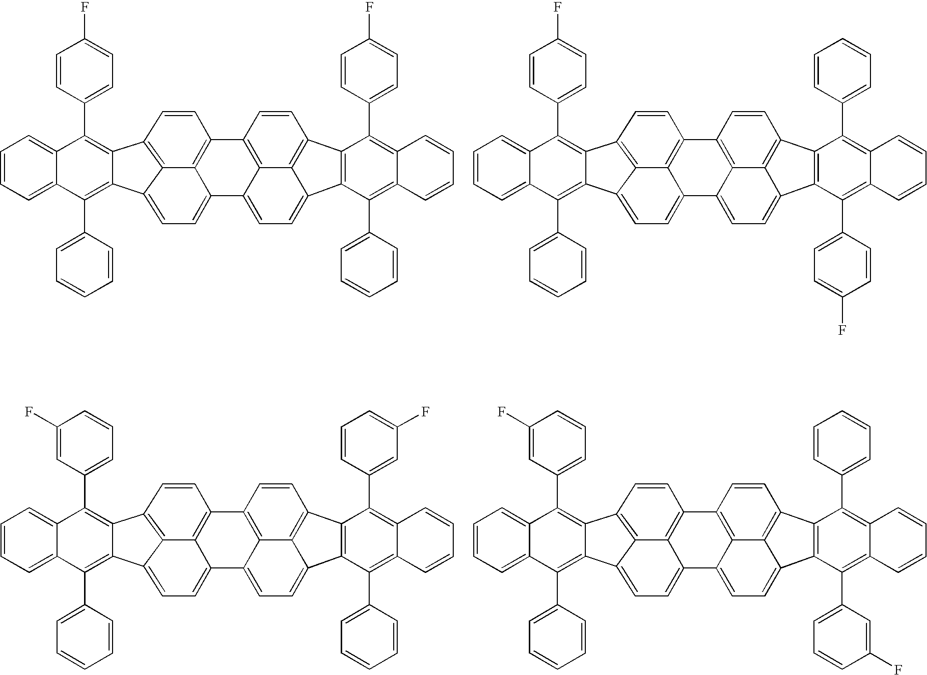

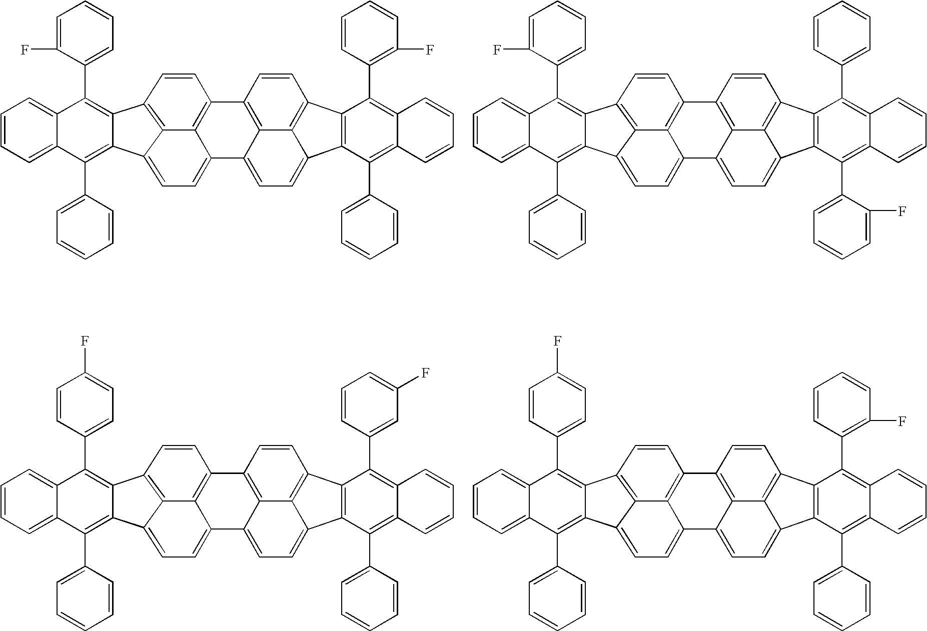

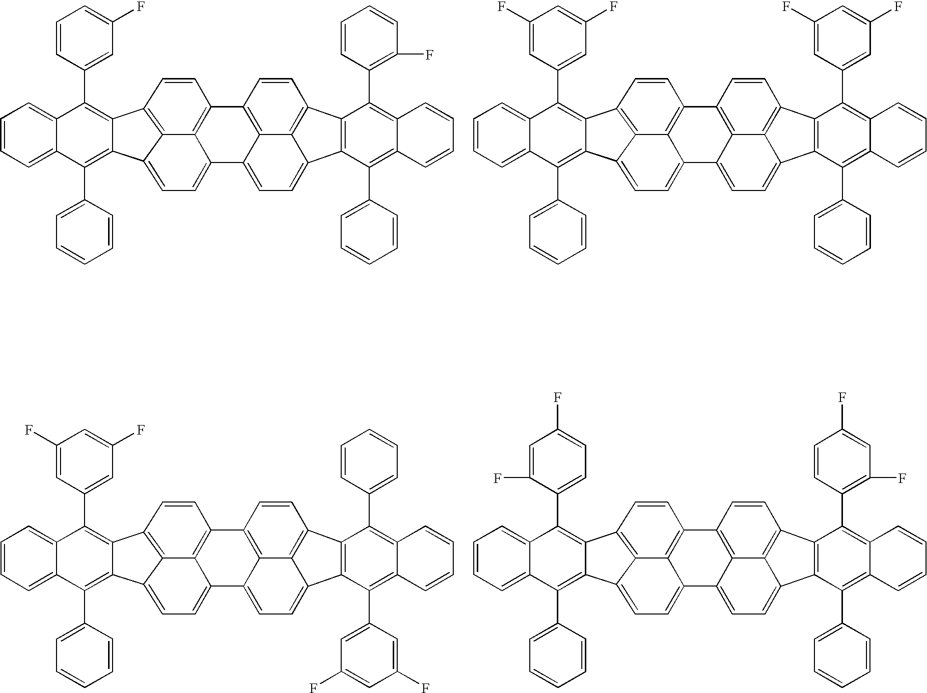

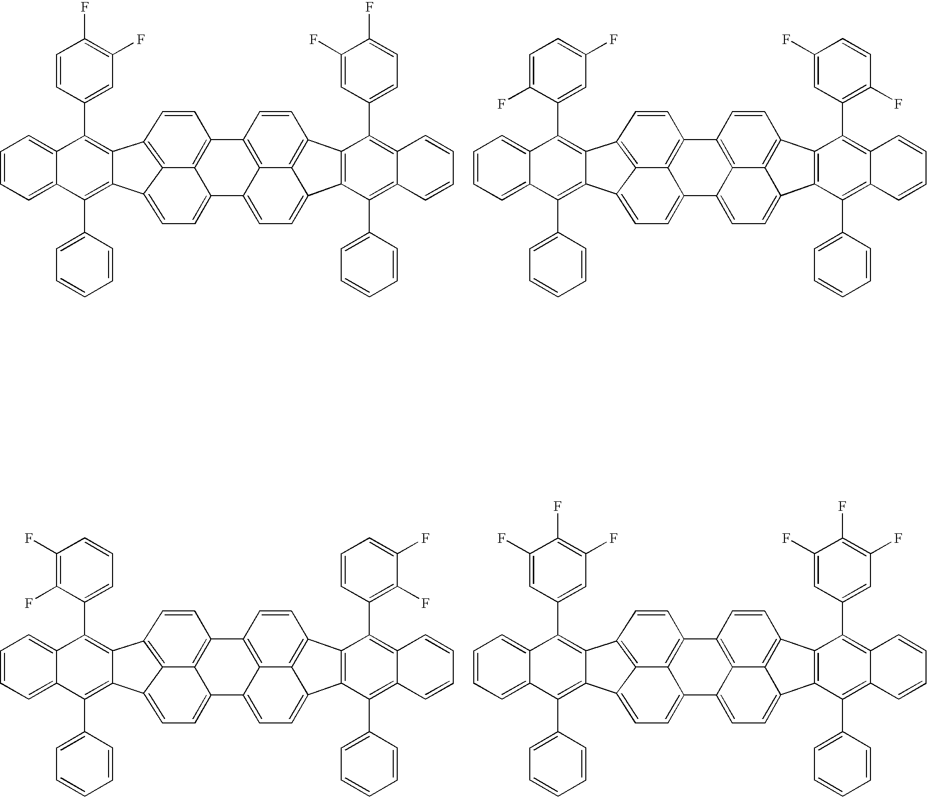

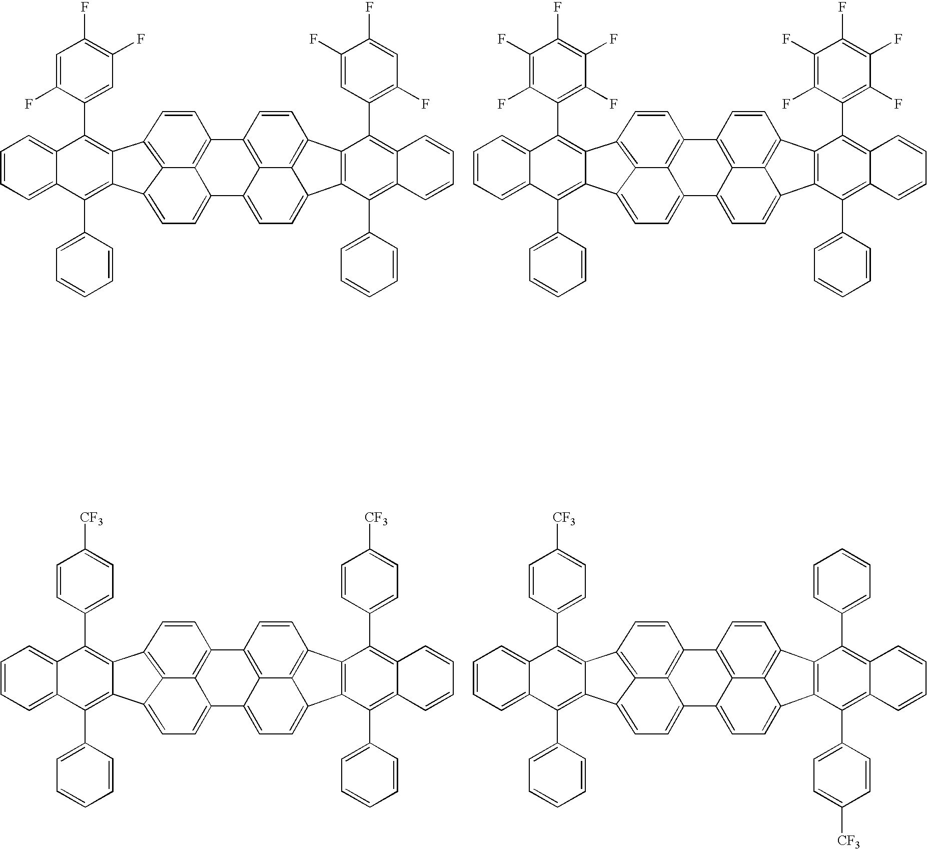

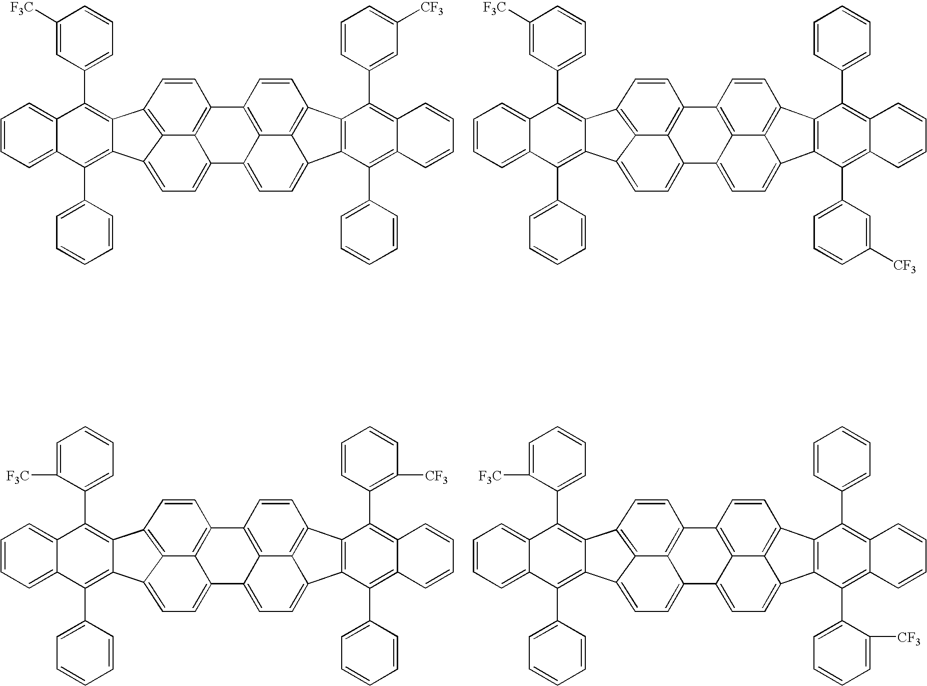

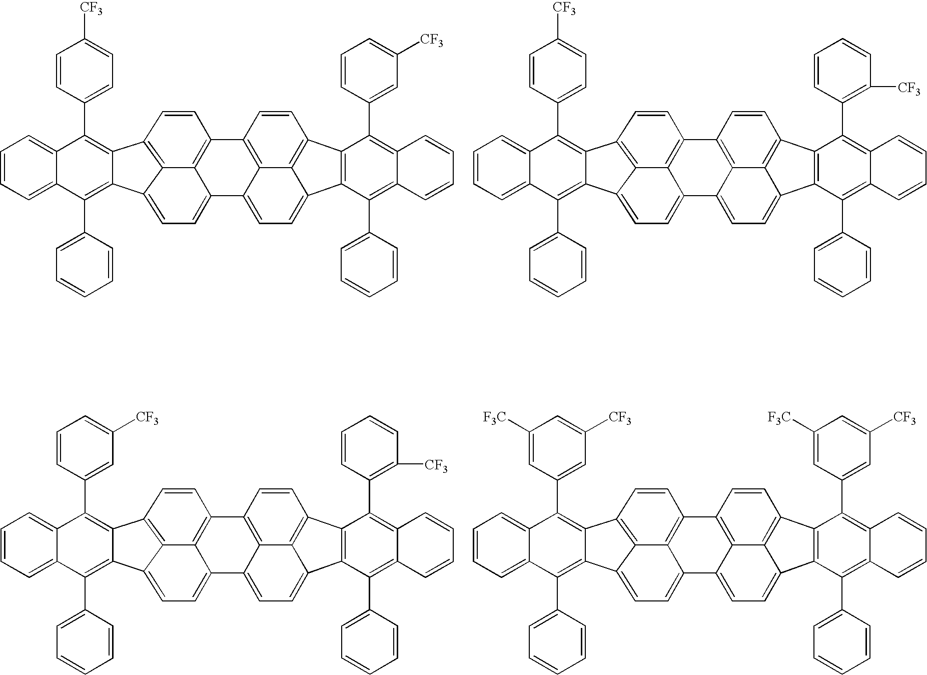

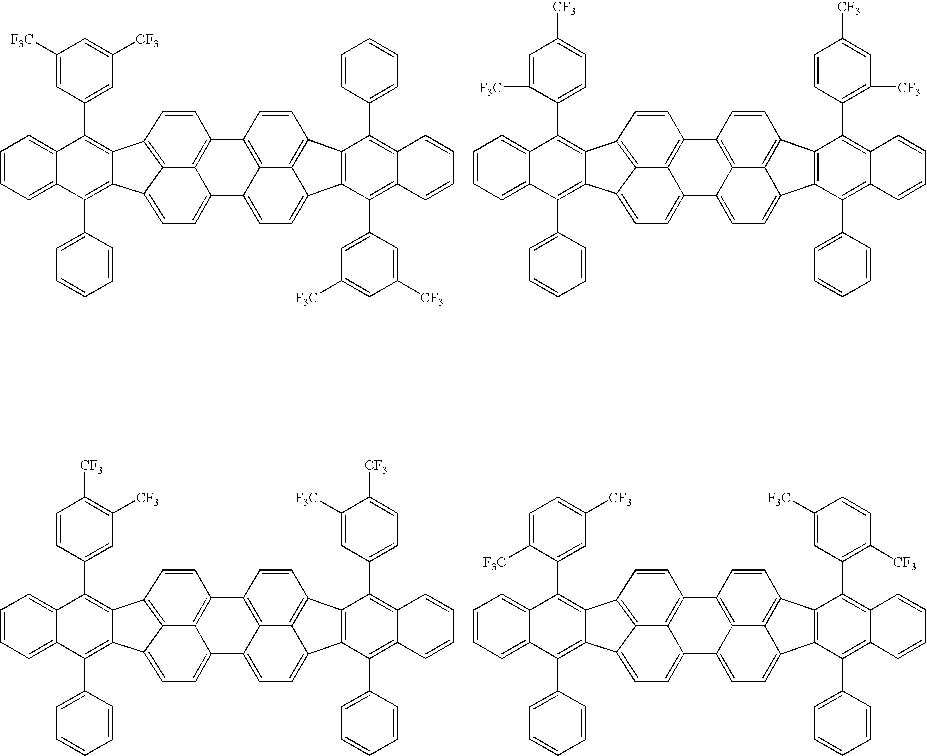

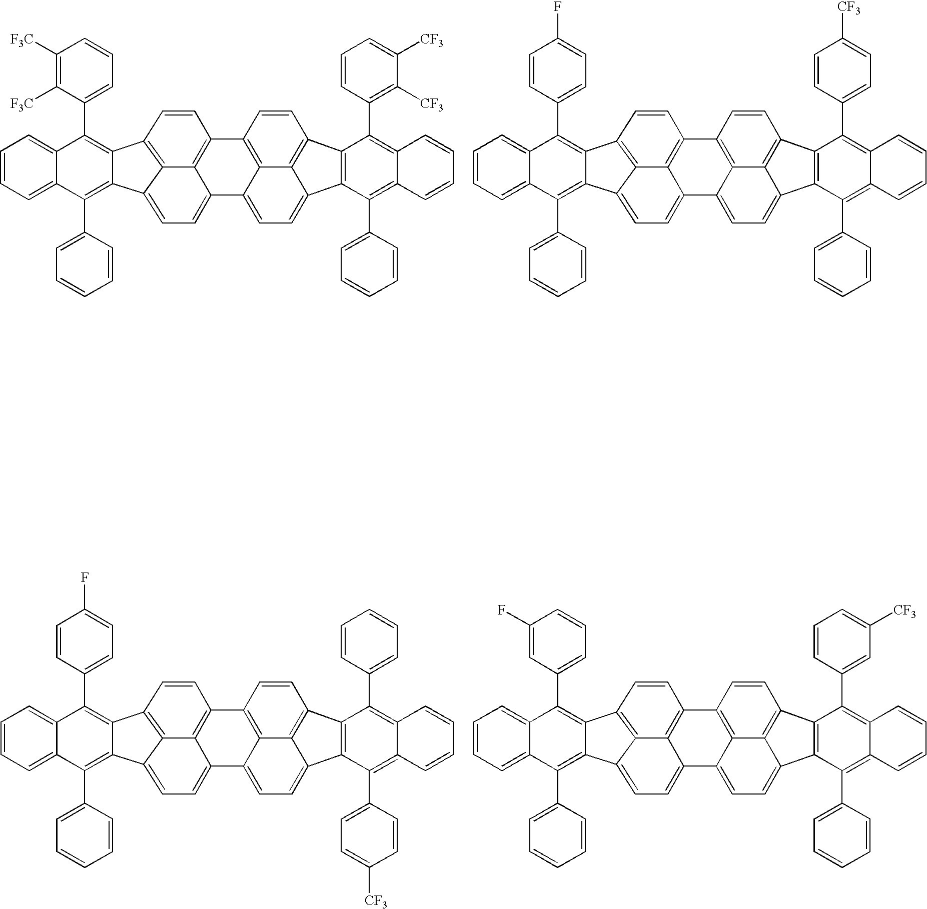

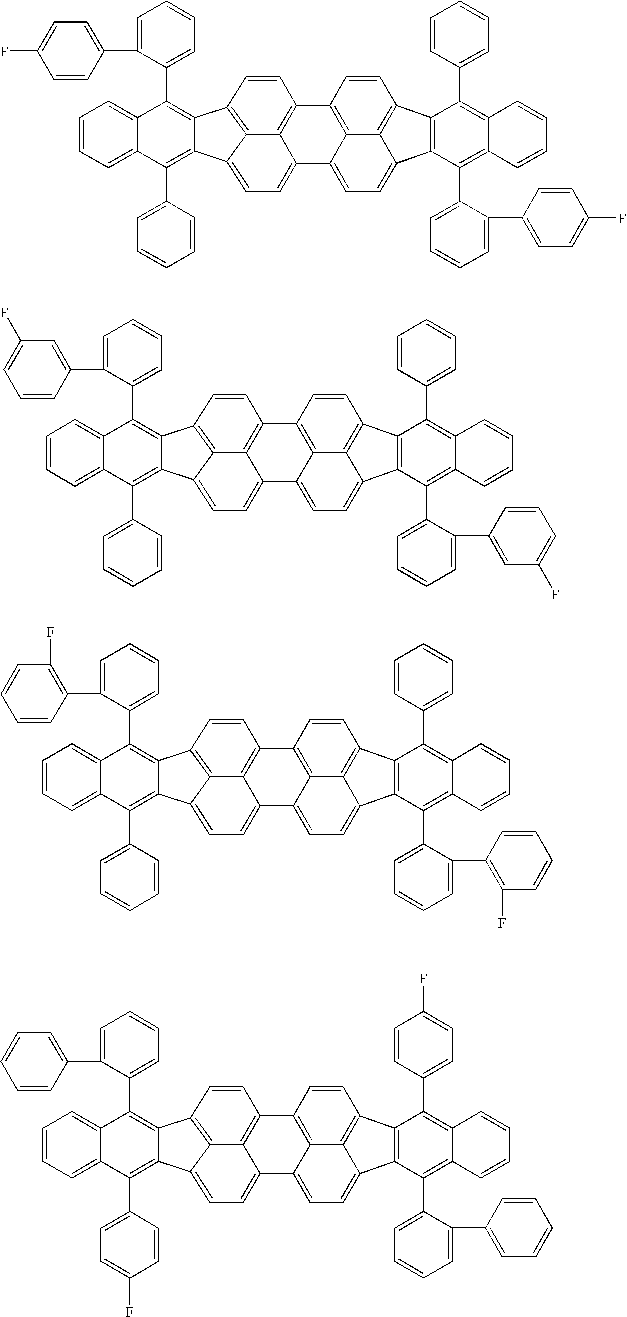

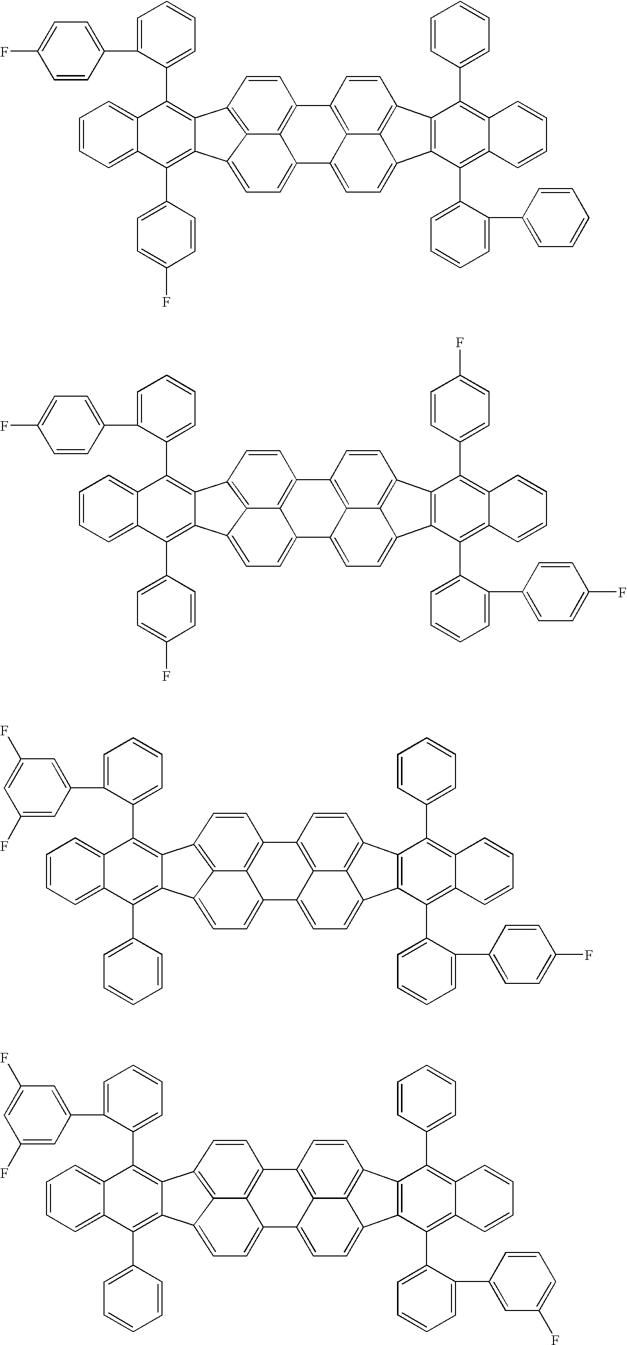

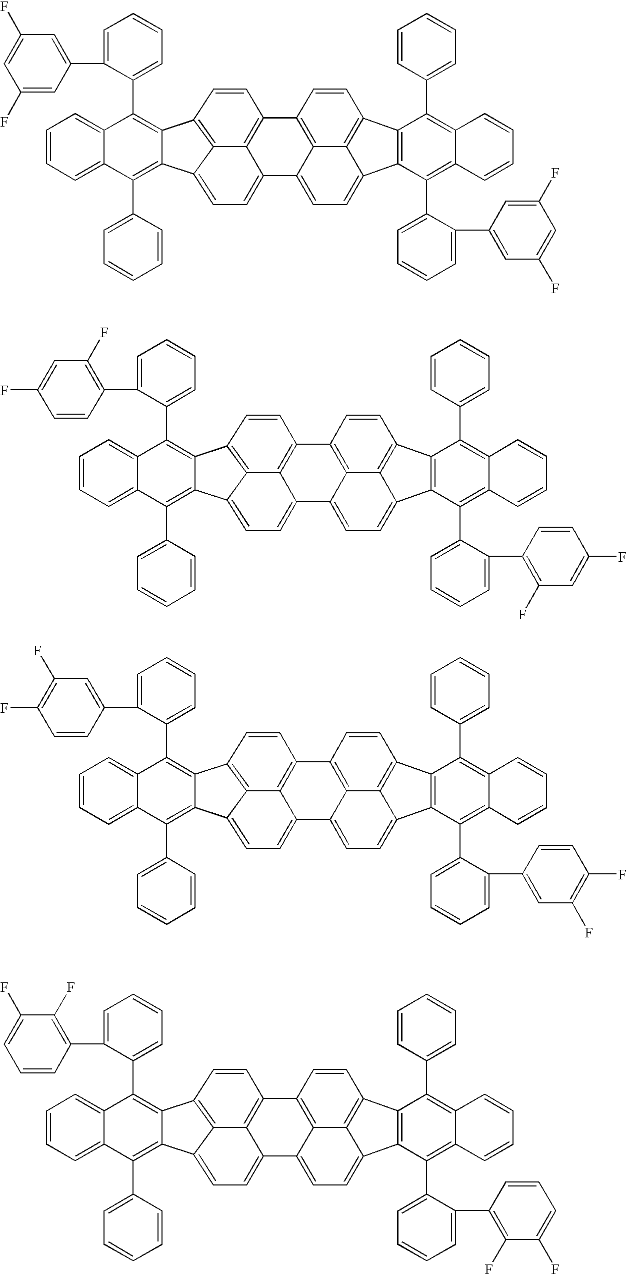

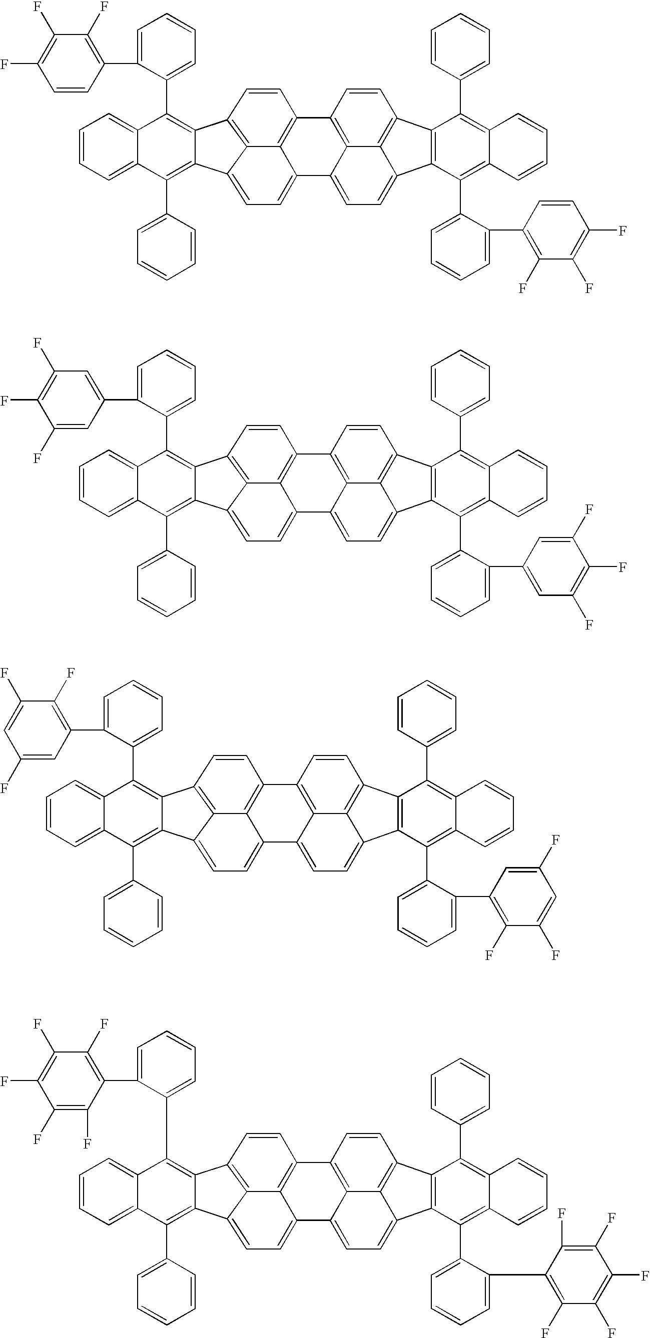

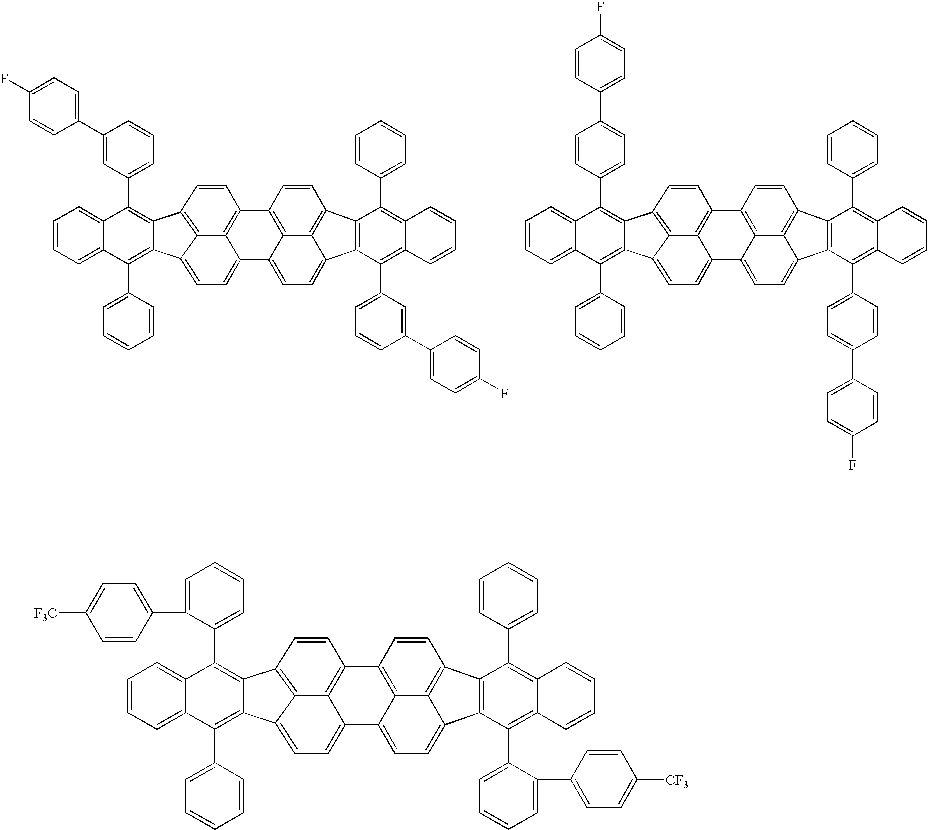

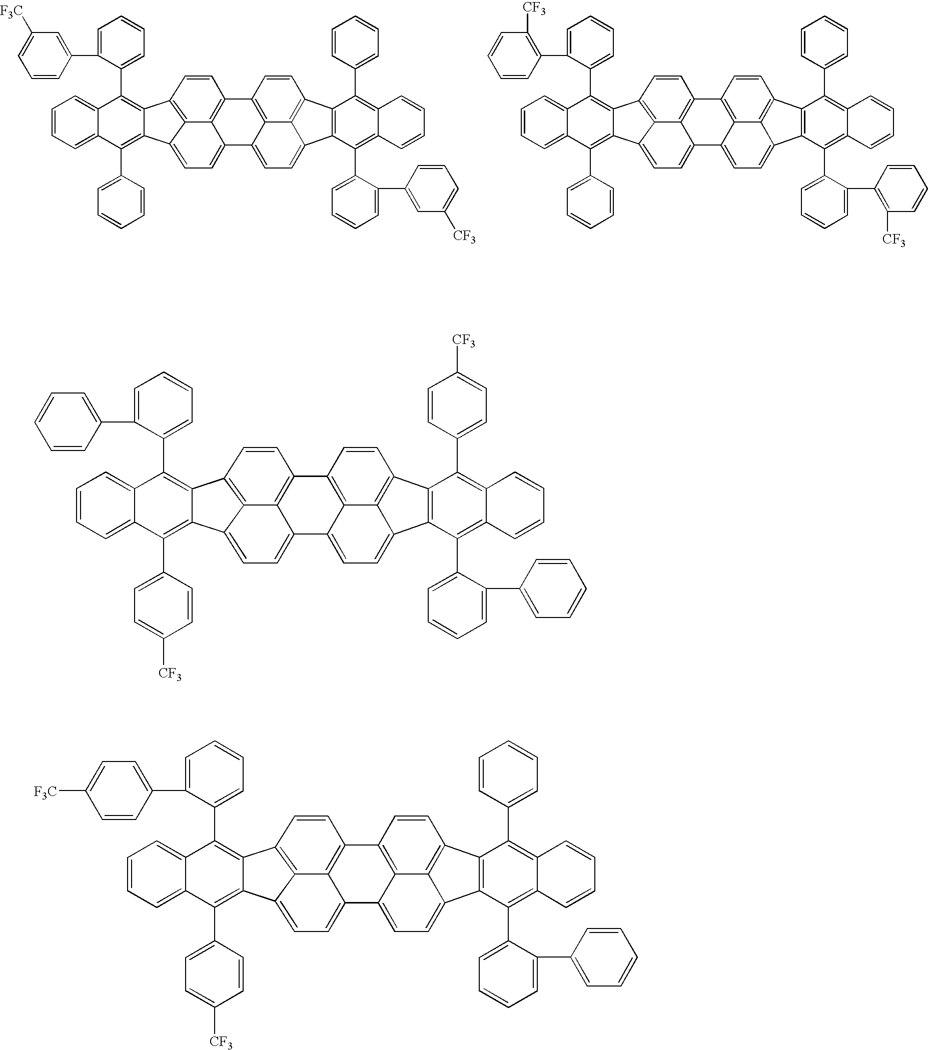

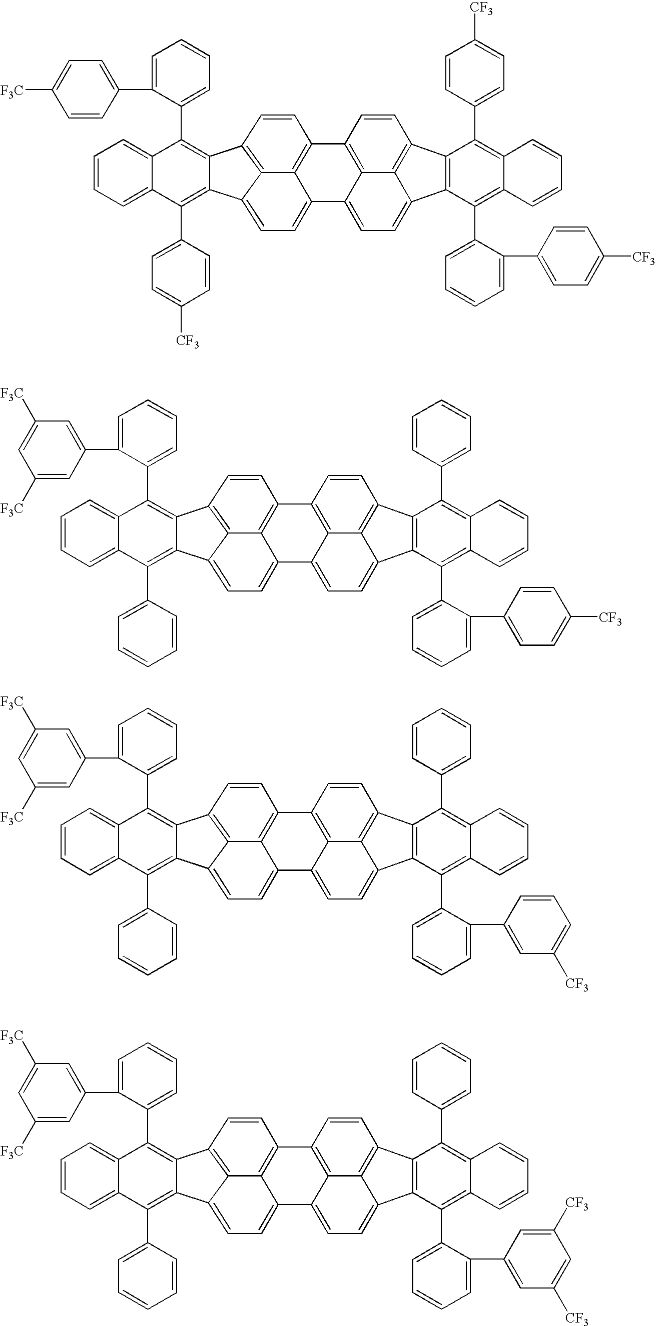

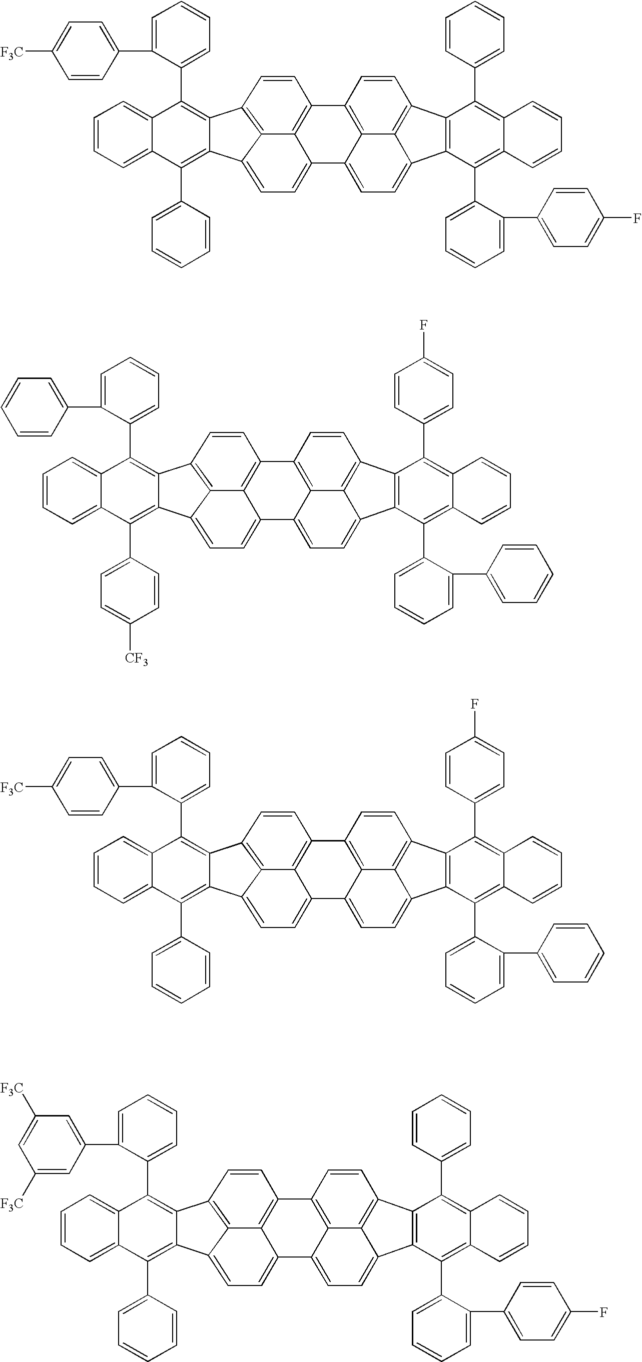

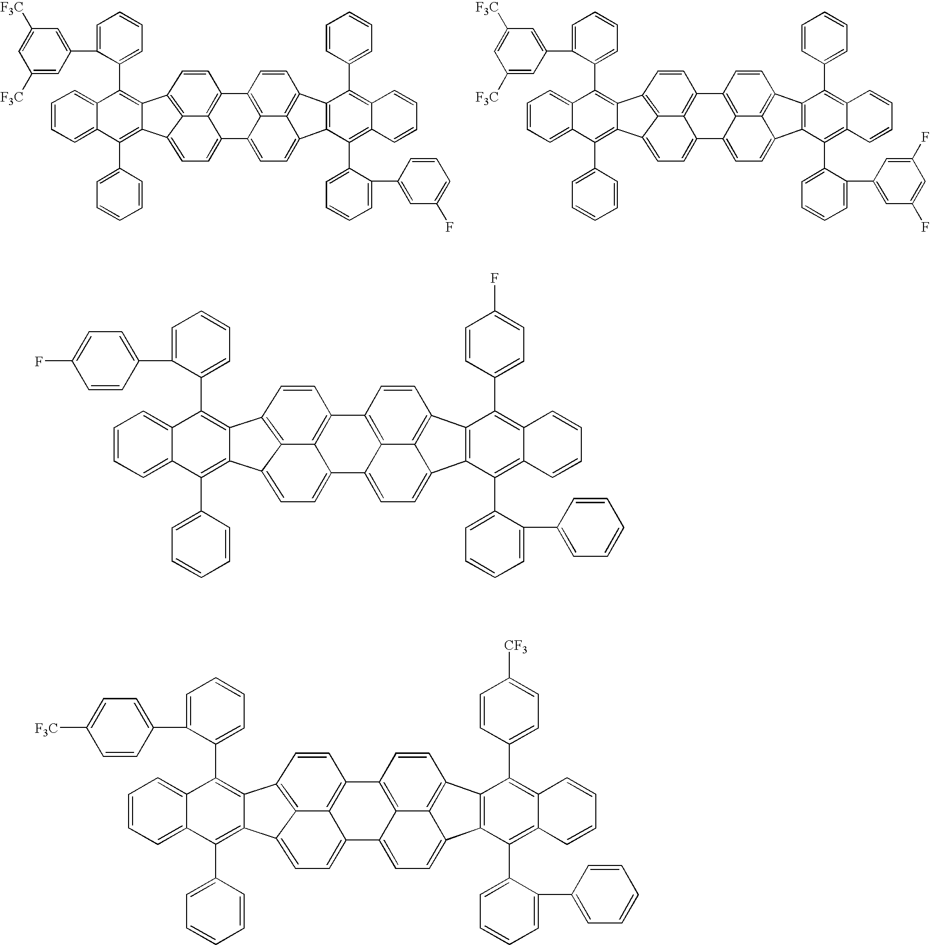

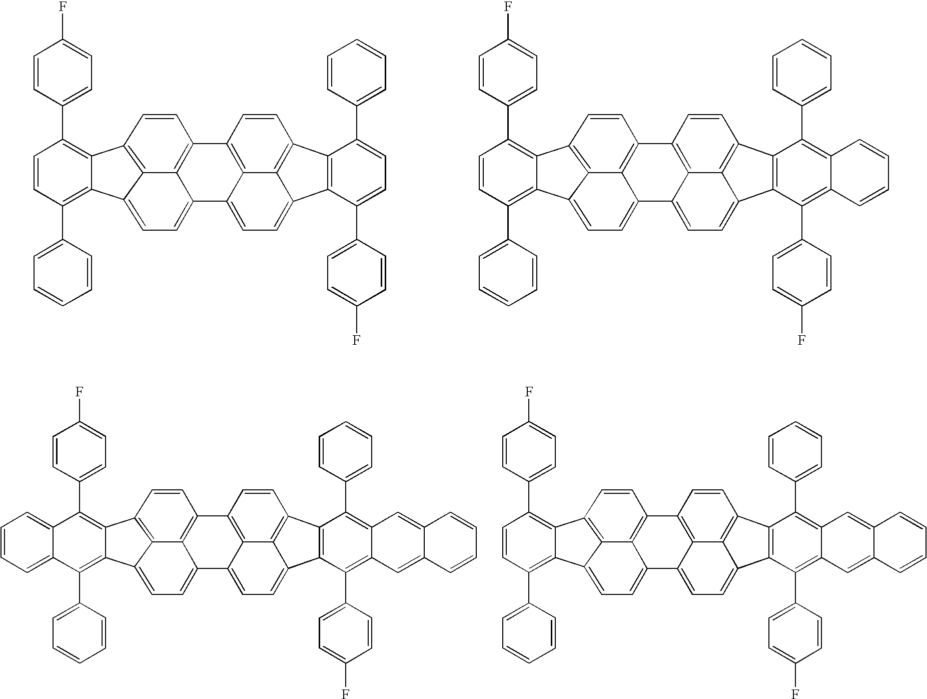

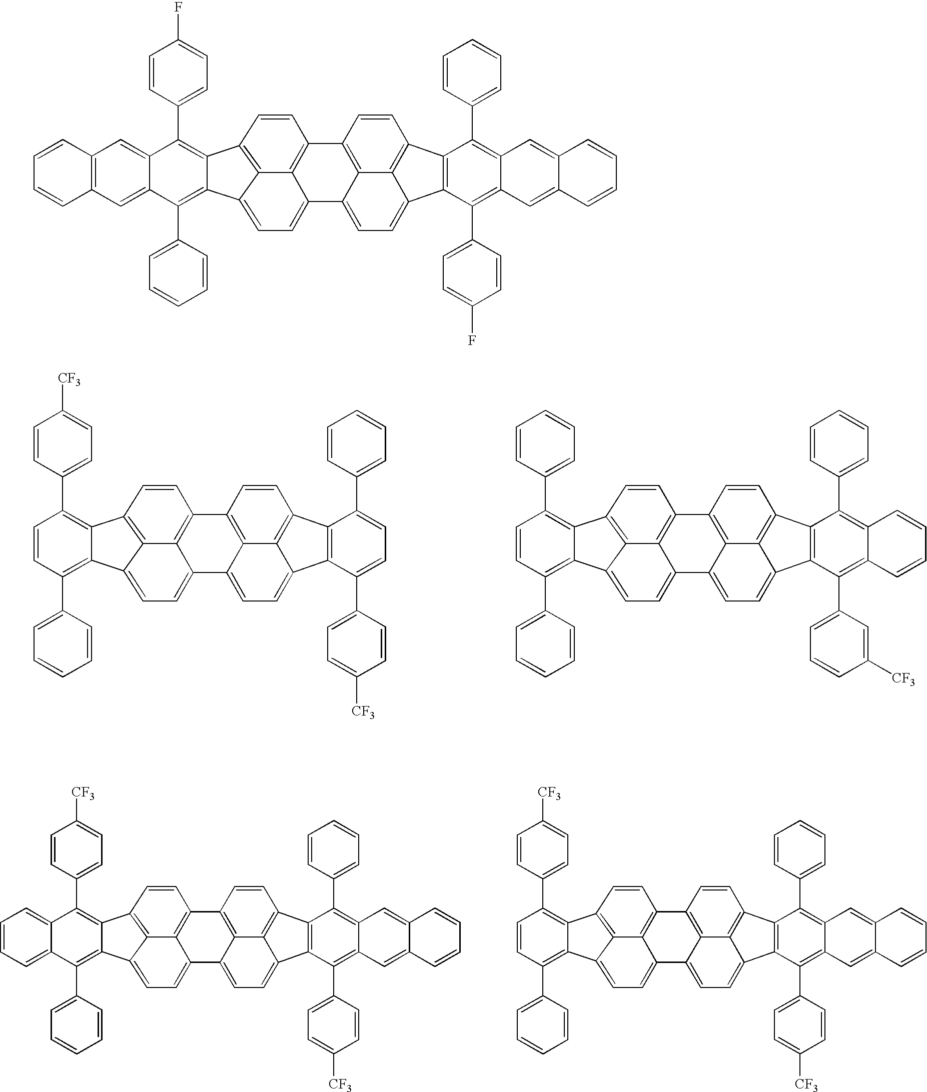

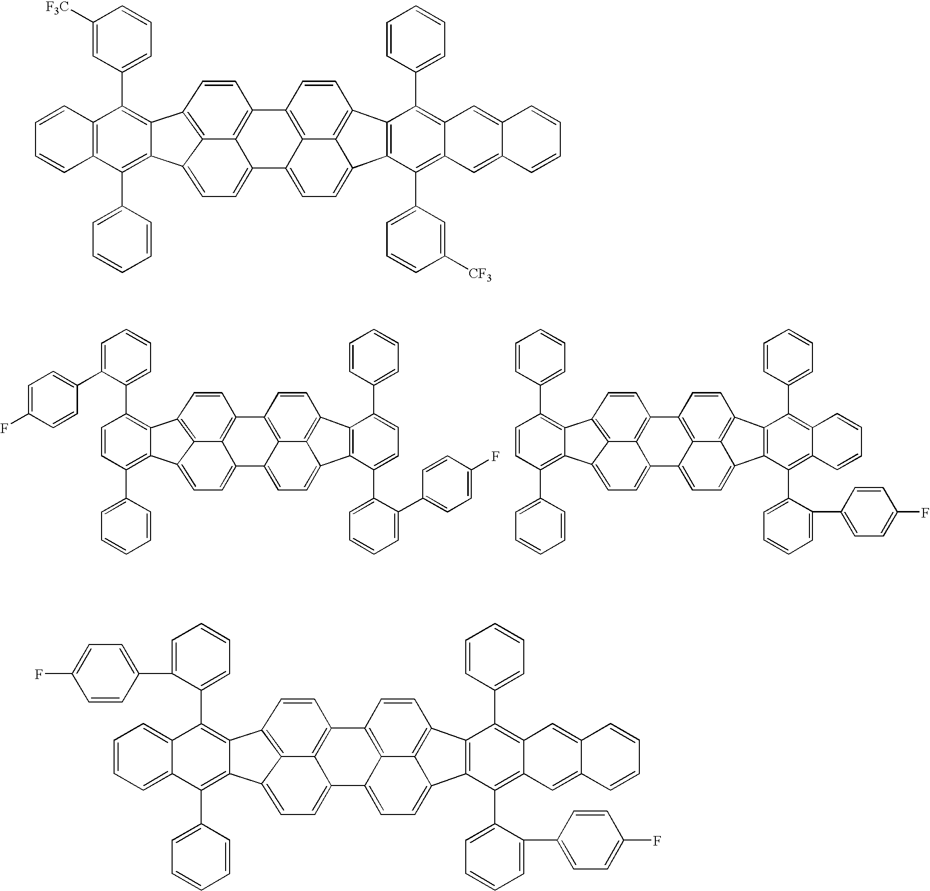

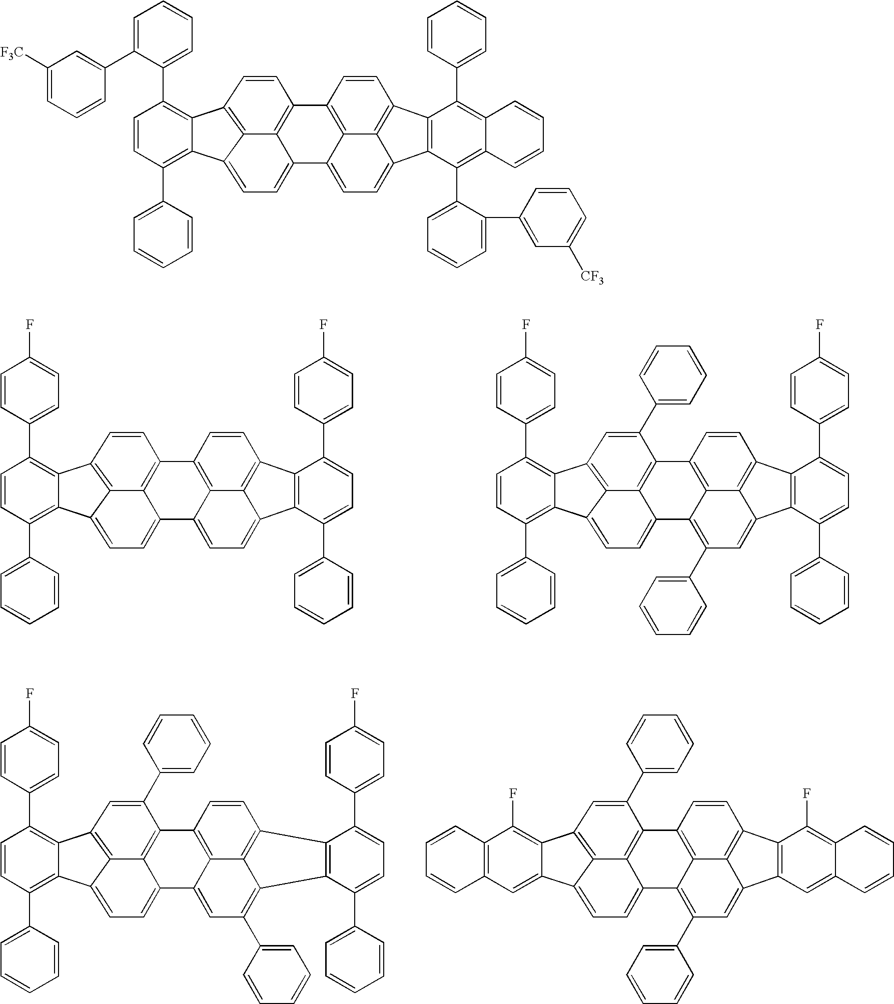

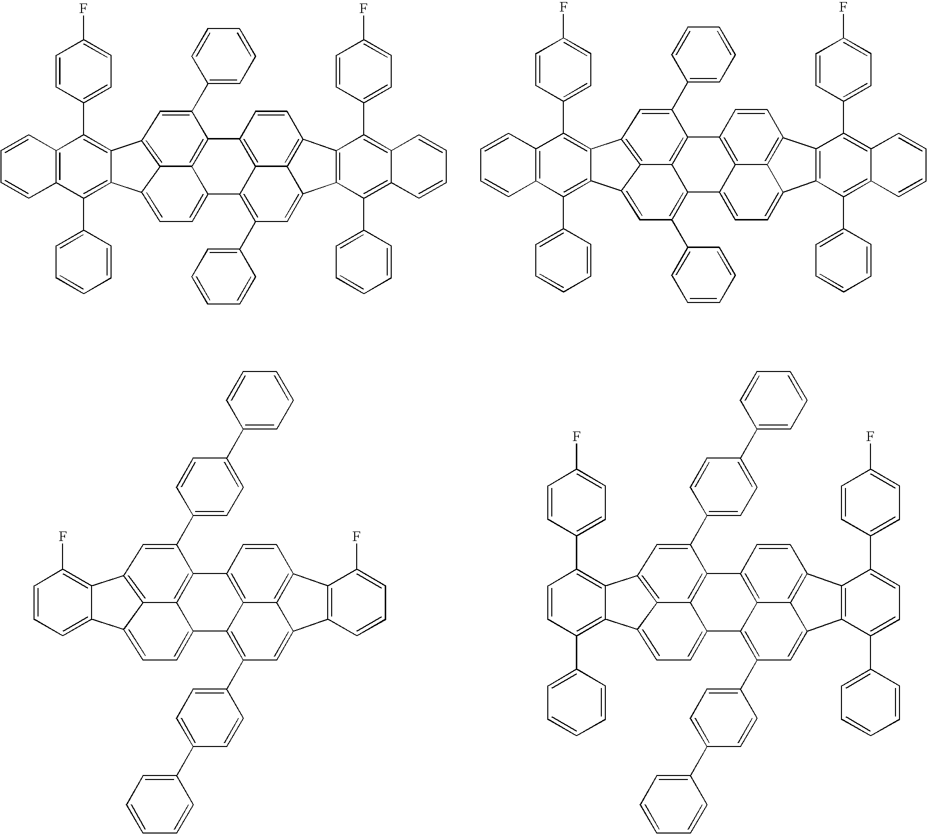

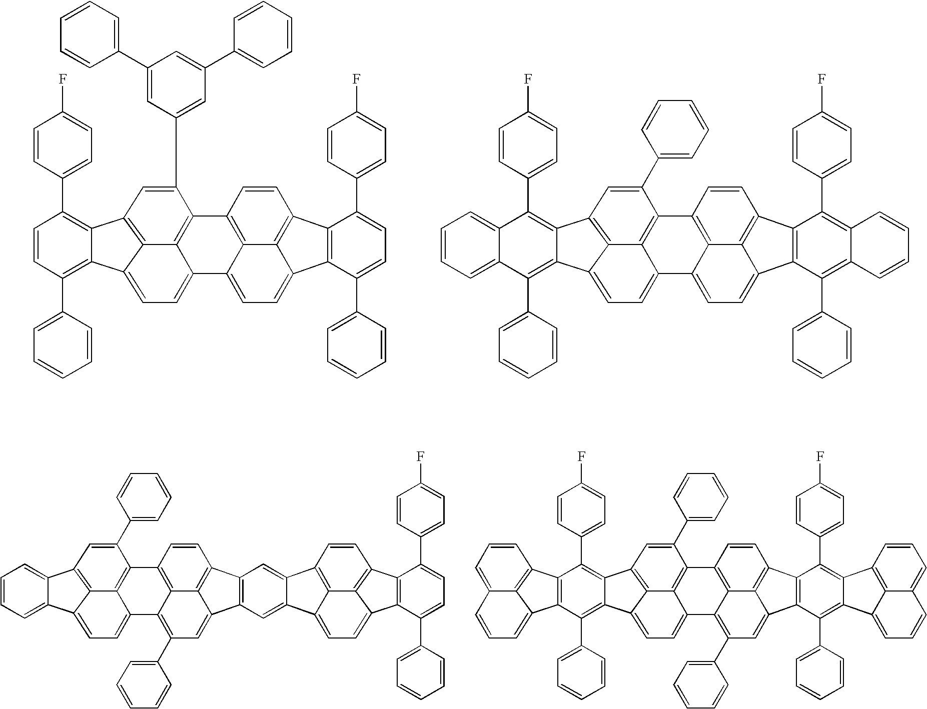

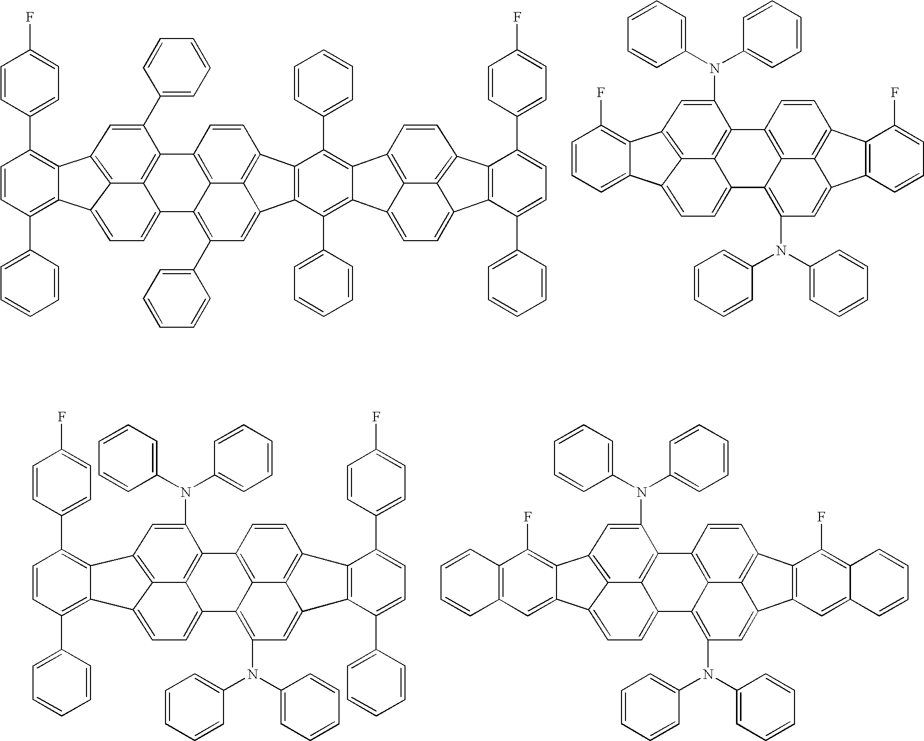

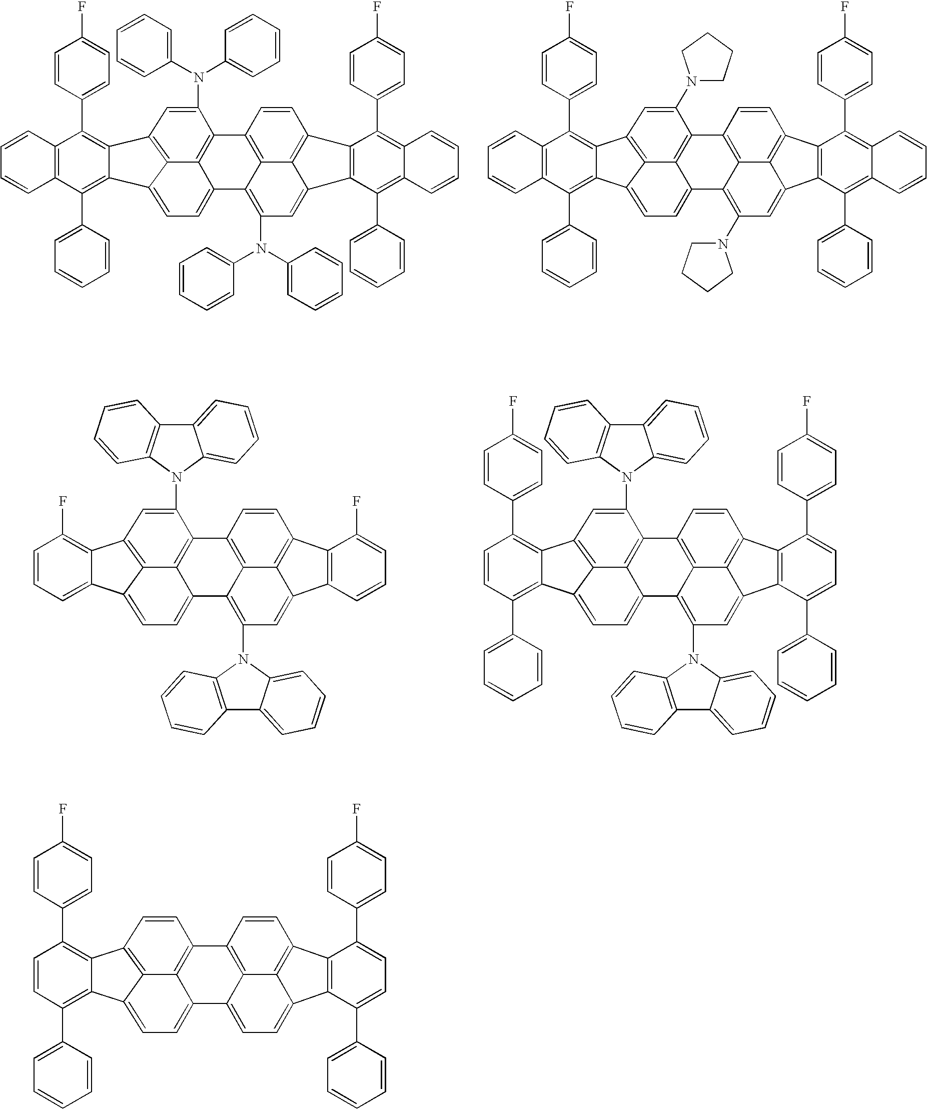

Next, (B) component is described below. Examples of the compound having a fused aromatic ring as the component (B) includes naphthacene derivatives, anthracene derivatives, bisanthracene derivatives, pyrene derivatives, bispyrene derivatives, diaminoanthracene derivatives, naphthofluoranthene derivatives, diaminopyrene derivatives, diaminoperylene derivatives, dibenzidine derivatives, aminoanthracene derivatives, aminopyrene derivatives, and dibenzochrysene derivatives.

Of those, an anthracene derivative represented by the following general formula (5), an asymmetric anthracene derivative represented by a general formula (6), an a symmetric pyrene derivative represented by a general formula (7), an asymmetric diphenylanthracene derivative represented by a general formula (8), a bispyrene derivative represented by a general formula (9), or a naphthacene derivative represented by a general formula (14) is preferable.

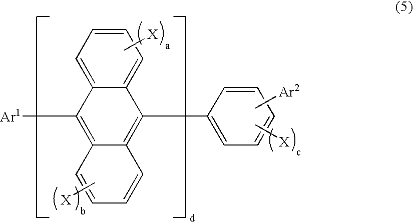

[In the general formula (5), X represents a hydrogen atom, a substituted or unsubstituted aromatic hydrocarbon group having 6 to 50 ring carbon atoms, a substituted or unsubstituted aromatic heterocyclic group having 5 to 50 ring carbon atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 carbon atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group, or a hydroxyl group;

Ar¹ and Ar² each independently represent a substituted or unsubstituted fused aromatic group having 10 to 50 ring carbon atoms, and at least one of Ar¹ and Ar² represents a 1-naphthyl group represented by the following general formula (5-1) or a 2-naphthyl group represented by the following general formula (5-2):

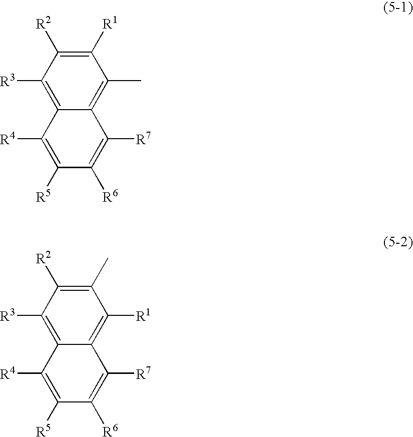

where R¹ to R⁷ each independently represent a hydrogen atom, or a substituted or unsubstituted alkyl group having 1 to 50 carbon atoms, and at least one pair of adjacent groups of R¹ to R⁷ includes a pair of alkyl groups which are bonded to each other to form a cyclic structure; and

a, b, and c each represent an integer of 0 to 4, d represents an integer of 1 to 3, and, when d represents 2 or more, groups in [ ] may be identical to or different from each other.]

Examples of the aromatic hydrocarbon group, aromatic heterocyclic group, alkyl group, substituted or unsubstituted alkoxy group having 1 to 50 carbon atoms, aralkyl group, aryloxy group, arylthio group, alkoxycarbonyl group (—COOR₁) each represented by X include examples similar to those described for X₁ to X₁₈ in the general formulae (1) and (2).

Examples of the cycloalkyl group represented by X include a cyclopropyl group, a cyclobutyl group, a cyclopentyl group, a cyclohexyl group, a 4-methylcyclohexyl group, a 1-adamantyl group, a 2-adamantyl group, a 1-norbornyl group, and a 2-norbornyl group. The cyclohexyl group is preferred.

Examples of the silyl group represented by X include a trimethyl silyl group, a triethyl silyl group, a t-butyldimethyl silyl group, a vinyldimethyl silyl group, and a propyldimethyl silyl group.

Examples of the fused aromatic ring group represented by any one of Ar₁ and Ar₂ include naphthalene, anthracene, phenanthrene, pyren, chrysene, triphenylene, and perylene.

Examples of the alkyl groups represented by R¹ to R⁷ include examples similar to those described above. The ring structure which R¹ to R⁷ form is, for example, cycloalkane having 4 to 12 carbon atoms such as cyclobutane, cyclopentane, cyclohexane, adamantane, and norbornane.

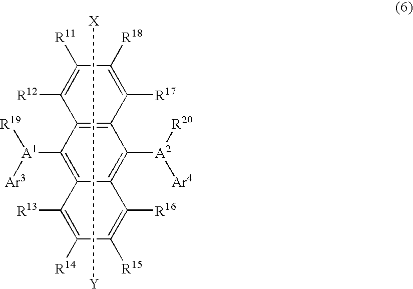

[In the general formula (6), A¹ and A² each independently represent a substituted or unsubstituted fused aromatic hydrocarbon group having 10 to 20 ring carbon atoms;

Ar³ and Ar⁴ each independently represent a hydrogen atom, or a substituted or unsubstituted aromatic hydrocarbon group having 6 to 50 ring carbon atoms;

R¹¹ to R²⁰ each independently represent a hydrogen atom, a substituted or unsubstituted aromatic hydrocarbon group having 6 to 50 ring carbon atoms, a substituted or unsubstituted aromatic heterocyclic group having 5 to 50 ring atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 carbon atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group, or a hydroxyl group; and

the number of each of Ar³, Ar⁴, R¹⁹, and R²⁰ may be two or more, and adjacent groups may form a saturated or unsaturated cyclic structure;

provided that there is no case where groups symmetric with respect to the X-Y axis shown on central anthracene in the general formula (6) bind to 9- and 10-positions of the anthracene.]

Examples of the fused aromatic ring represented by any one of A¹ and A² include examples each having a corresponding number of carbon atoms out of the examples listed in Ar¹ and Ar² in the general formula (5).

Examples of each of the groups Ar³, Ar⁴, and R¹¹ to R²⁰ include examples similar to those described above, and examples of the cyclic structure which Ar³s, Ar⁴s, R¹⁹s, or R²⁰s may form include examples similar to those described above.

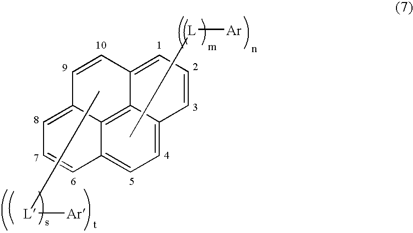

[In the general formula (7), Ar and Ar′ each independently represent a substituted or unsubstituted aromatic group having 6 to 50 ring carbon atoms;

L and L′ each independently represent a substituted or unsubstituted phenylene group, a substituted or unsubstituted naphthalenylene group, a substituted or unsubstituted fluorenylene group, or a substituted or unsubstituted dibenzosilolylene group;

m represents an integer of 0 to 2; n represents an integer of 1 to 4; s represents an integer of 0 to 2; t represents an integer of 0 to 4; and

in addition, L or Ar binds to any one of 1- to 5-positions of pyrene, and L′ or Ar′ binds to any one of 6- to 10-positions of pyrene;

provided that Ar, Ar′, L, and L′ satisfy the following item (1) or (2) when n+t represents an even number,

(1) Ar≠Ar′ and/or L≠L′ (where the symbol “≠” means that groups connected with the symbol have different structures)

### (2) When Ar=Ar′ and L=L′,

(2-1) m≠s and/or n≠t, or
(2-2) when m=s and n=t,
   (2-2-1) L and L′ (or pyrene) bind (or binds) to different binding positions on Ar and Ar′, or
   (2-2-2) in the case where L and L′ (or pyrene) bind (or binds) to the same binding positions on Ar and Ar′, the substitution positions of L and L′, or of Ar and Ar′ in pyrene are not symmetrically related.]

Examples of the aromatic group represented by any one of Ar and Ar′ include examples similar to those of the aromatic hydrocarbon group and the aromatic heterocyclic group listed in the general formula (5).

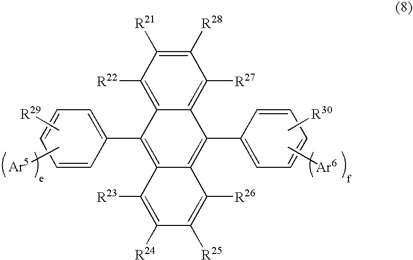

[In the general formula (8), Ar⁵ and Ar² each independently represent a substituted or unsubstituted aromatic hydrocarbon group having 6 to 50 ring carbon atoms; e and f each represent an integer of 1 to 4; provided that Ar⁵ and Ar⁶ are not identical to each other when e=f=1 and positions at which Ar⁵ and Ar⁶ are bound to a benzene ring are bilaterally symmetric, and e and f represent different integers when e or f represents an integer of 2 to 4;

R²¹ to R²⁸ each independently represent a hydrogen atom, a substituted or unsubstituted aromatic hydrocarbon group having 6 to 50 ring carbon atoms, a substituted or unsubstituted aromatic heterocyclic group having 5 to 50 ring atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 carbon atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group, or a hydroxyl group; and

R²⁹ to R³⁰ each independently represent a hydrogen atom, a substituted or unsubstituted aromatic hydrocarbon group having 6 to 50 ring carbon atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 carbon atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group, or a hydroxyl group.]

Examples of each of groups Ar⁵, Ar⁶, and R²¹ to R³⁰ include examples similar to those of the general formula (5).

(A)ₖ-(X¹)_{g}—(Ar⁷)ₕ—(Y¹)ₚ—(B)_{q} (9)

[In the general formula (9), X¹ represents a substituted or unsubstituted pyrene residue;

A and B each independently represent a hydrogen atom, a substituted or unsubstituted aromatic hydrocarbon group having 3 to 50 ring carbon atoms, a substituted or unsubstituted aromatic heterocyclic group having 3 to 50 ring atoms, a substituted or unsubstituted alkyl or alkylene group having 1 to 50 carbon atoms, or a substituted or unsubstituted alkenyl or alkenylene group having 1 to 50 carbon atoms;

Ar⁷ represents a substituted or unsubstituted aromatic hydrocarbon group having 3 to 50 ring carbon atoms and/or a substituted or unsubstituted aromatic heterocyclic group having 3 to 50 ring atoms;

Y¹ represents a substituted or unsubstituted fused ring group having 5 to 50 ring carbon atoms and/or a substituted or unsubstituted fused heterocyclic group having 5 to 50 ring atoms; and

g represents an integer of 1 to 3, k and q each represent an integer of 0 to 4, p represents an integer of 0 to 3, and h represents an integer of 1 to 5.]

Examples of each of the A and B groups include examples similar to those described for the general formula (5) or divalent groups thereof.

Examples of the fused ring group and/or fused heterocyclic group represented by Y¹ having 5 to 50 ring carbon atoms include residues of pyrene, anthracene, benzanthracene, naphthalene, fluoranthene, fluorene, benzfluorene, diazafluorene, phenanthrene, tetracene, coronene, chrysene, fluoresceine, perylene, phthaloperylene, naphthaloperylene, perinone, phthaloperinone, naphthaloperinone, diphenylbutadiene, tetraphenylbutadiene, coumarin, oxadiazole, aldazine, bisbenzoxazoline, bisstyryl, pyrazine, cyclopentadiene, imine, diphenylethylene, vinylanthracene, diaminocarbazole, pyrane, thiopyrane, polymethine, merocyanine, imidazole-chelated oxynoid compounds, quinacridone, rubrene, stilbene-based derivatives, and fluorescent dyes. The residues of pyrene, anthracene, and fluoranthene are preferred.

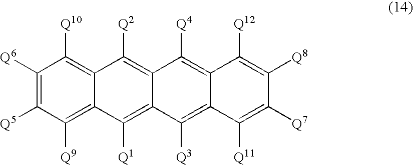

[In the general formula (14), Q¹ to Q¹² each independently represent a hydrogen atom, a substituted or unsubstituted alkyl group having 1 to 20 carbon atoms, a substituted or unsubstituted aromatic hydrocarbon group having 6 to 50 ring carbon atoms, an amino group, a substituted or unsubstituted alkoxy group having 1 to 20 carbon atoms, a substituted or unsubstituted alkylthio group having 1 to 20 carbon atoms, a substituted or unsubstituted aryloxy group having 6 to 20 ring carbon atoms, a substituted or unsubstituted arylthio group having 6 to 20 ring carbon atoms, a substituted or unsubstituted alkenyl group having 2 to 20 carbon atoms, a substituted or unsubstituted aralkyl group having 7 to 20 ring carbon atoms, or a substituted or unsubstituted aromatic heterocyclic group having 6 to 20 ring atoms, Q¹ to Q¹² may be identical to or different from one another, and adjacent groups of Q¹ to Q¹² may form a saturated or unsaturated cyclic structure.]

Examples of each of the groups Q¹ to Q¹² in the general formula (14) include examples similar to those listed in X₁ to X₁₈ in the general formulae (1) and (2).

In addition, examples of the saturated or unsaturated cyclic structure formed of adjacent groups include the following examples.

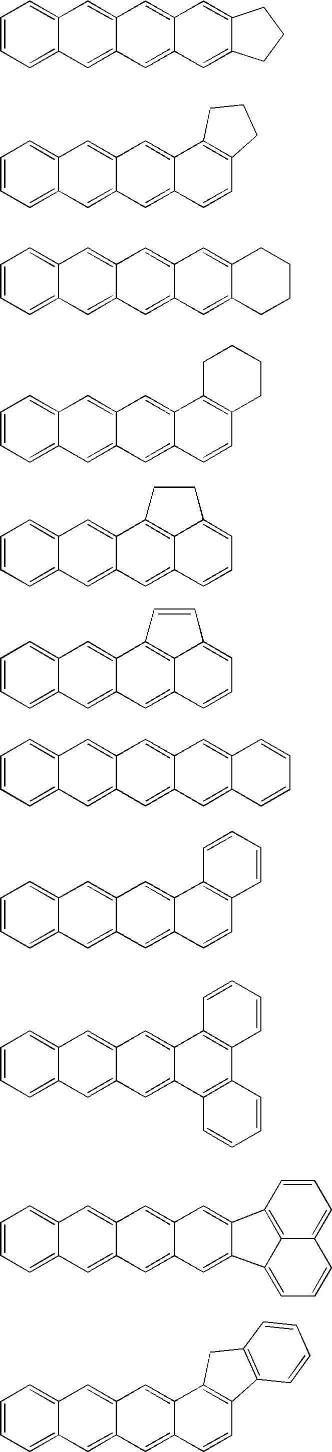

At least one of Q¹, Q², Q³, and Q⁴ in the general formula (14) preferably represents an aromatic hydrocarbon group.

The naphthacene derivative represented by the general formula (14) preferably has a structure represented by the following general formula (15).

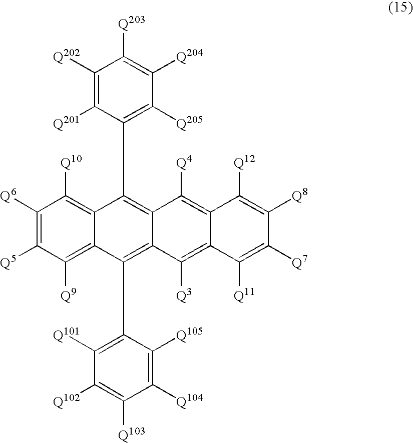

[In the general formula (15), Q³ to Q¹², Q¹⁰ to Q¹⁰⁵, and Q²⁰¹ to Q²⁰⁵ each independently represent the same group as that represented by any one of Q¹ to Q¹² described above, Q³ to Q¹², Q¹⁰¹ to Q¹⁰⁵, and Q²⁰¹ to Q²⁰⁵ may be identical to or different from one another, and adjacent groups of Q³ to Q¹², Q¹⁰¹ to Q¹⁰⁵, and Q²⁰¹ to Q²⁰⁵ may form a saturated or unsaturated cyclic structure.]

Examples of each of the groups Q³ to Q¹², Q¹⁰¹ to Q¹⁰⁵, and Q²⁰¹ to Q²⁰⁵ in the general formula (15) include examples similar to those listed in X₁ to X₁₈ in the general formulae (1) and (2). In addition, examples of the cyclic structure include examples similar to those in the case of the general formula (14).

At least one of Q¹⁰¹, Q¹⁰⁵, Q²⁰¹, and Q²⁰⁵ in the general formula (15) preferably represents a substituted or unsubstituted alkyl group having 1 to 20 carbon atoms, a substituted or unsubstituted aromatic hydrocarbon group having 6 to 50 ring carbon atoms, an amino group, a substituted or unsubstituted alkoxy group having 1 to 20 carbon atoms, a substituted or unsubstituted alkylthio group having 1 to 20 carbon atoms, a substituted or unsubstituted aryloxy group having 6 to 20 ring carbon atoms, a substituted or unsubstituted arylthio group having 6 to 20 ring carbon atoms, a substituted or unsubstituted alkenyl group having 2 to 20 carbon atoms, a substituted or unsubstituted aralkyl group having 7 to 20 ring carbon atoms, or a substituted or unsubstituted aromatic heterocyclic group having 6 to 20 ring atoms.

Examples of the substituents in the respective general formulae of the components (A) and (B) include a substituted or unsubstituted aromatic hydrocarbon group having 6 to 50 ring carbon atoms, a substituted or unsubstituted aromatic heterocyclic group having 5 to 50 ring atoms, a substituted or unsubstituted alkyl group having 1 to 50 carbon atoms, a substituted or unsubstituted cycloalkyl group having 3 to 50 ring carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 ring atoms, a substituted or unsubstituted arylthio group having 5 to 50 ring atoms, a substituted or unsubstituted alkoxycarbonyl group having 1 to 50 carbon atoms, a substituted or unsubstituted silyl group, a carboxyl group, a halogen atom, a cyano group, a nitro group, and a hydroxyl group.

In the organic EL device of the present invention, it is preferable that the light emitting layer contain the compound as the component (A) and the compound as the component (B), and it is more preferable that the compound as the component (A) be a dopant and the compound as the component (B) be a host material.

In addition, the light emitting layer contains the perylene compound as a dopant at a content of preferably 0.1 to 10 wt %, or more preferably 0.5 to 2 wt %.

The organic EL device of the present invention can emit red light having a high color purity by combining the components (A) and (B) and by introducing at least one halogen atom in each molecule of the perylene compound represented by the general formula (1) and/or the general formula (2) as the component (A) while an effect of the device, that is, the emission of light having a long wavelength is not impaired. Further, the association of the molecules of the compound is suppressed by an effect of the halogen atom, so the device hardly receives a detrimental effect such as a reduction in its efficiency due to a variation in concentration at which the light emitting layer is doped with the perylene compound. Accordingly, the achievement of stable production of the light emitting device can be expected. In addition, a compound having a fused aromatic ring having 10 to 50 ring carbon atoms like the component (B), in particular, a compound of an asymmetric structure having such fused aromatic ring has the following characteristic: the molecules of the compound sterically hinder each other to a large extent, so the concentration quenching of the device due to the association of the molecules can be prevented. In addition, the lifetime of the device can be additionally lengthened by incorporating the compound into the light emitting layer. As a result, the device can emit red light having a high color purity while maintaining high luminous efficiency and a long lifetime.

It should be noted that red luminescent colors in the organic EL device can be divided into the following three colors depending on the maximum luminous wavelength of the emission spectrum of the device: an orange color (maximum luminous wavelength: 585 to 595 nm), a red color (maximum luminous wavelength: 595 to 620 nm), and a pure red color (maximum luminous wavelength: 620 to 700 nm).

The emission of red light in a red light emitting device showing a luminescent color ranging from a yellow color to an orange color or a red color is such that a value for CIEx in the CIE chromaticity coordinates of the color of the emitted light is 0.62 or more (preferably 0.62 or more and less than 0.73), and the emission of orange light in the device is such that a value for CIEx in the CIE chromaticity coordinates of the color of the emitted light is 0.54 or more and less than 0.62.

The organic EL device of the present invention is preferably such that various intermediate layers are interposed among the pair of electrodes and the light emitting layer. Examples of the intermediate layers include a hole injecting layer, a hole transporting layer, an electron injecting layer, and an electron transporting layer.

A representative structure of the organic EL device will be described in the following:

(1) an anode/light emitting layer/cathode;

(2) an anode/hole injecting layer/light emitting layer/cathode;

(3) an anode/light emitting layer/electron injecting layer/cathode;

(4) an anode/hole injecting layer/light emitting layer/electron injecting layer/cathode;

(5) an anode/organic semiconductor layer/light emitting layer/cathode;

(6) an anode/organic semiconductor layer/electron barrier layer/light emitting layer/cathode;

(7) an anode/organic semiconductor layer/light emitting layer/adhesion improving layer/cathode;

(8) an anode/hole injecting layer/hole transporting layer/light emitting layer/electron injecting layer/cathode;

(9) an anode/insulating layer/light emitting layer/insulating layer/cathode;

(10) an anode/inorganic semiconductor layer/insulating layer/light emitting layer/insulating layer/cathode;

(11) an anode/organic semiconductor layer/insulating layer/light emitting layer/insulating layer/cathode;

(12) an anode/insulating layer/hole injecting layer/hole transporting layer/light emitting layer/insulating layer/cathode; and

(13) an anode/insulating layer/hole injecting layer/hole transporting layer/light emitting layer/electron injecting layer/cathode.

Of those, the structure (8) is preferably used in ordinary cases. However, the structure is not limited to the foregoing.

The organic EL device is generally prepared on a light-transmissive substrate. Here, the light-transmissive substrate is the substrate which supports the organic EL device. It is preferable that the light-transmissive substrate have a transmittance of light of 50% or higher in the visible region of 400 to 700 nm and be also flat and smooth.

As examples of the light-transmissive substrate, glass plates and synthetic resin plates are suitably used. Specific examples of the glass plate include plates formed of soda-lime glass, glass containing barium and strontium, lead glass, aluminosilicate glass, borosilicate glass, barium borosilicate glass, and quartz. Specific examples of the synthetic plate include plates formed of a polycarbonate resin, an acrylic resin, a polyethylene terephthalate resin, a polyether sulfide resin, and a polysulfone resin.

Next, one using a metal, alloy, or conductive compound having a large work function (4 eV or more), or a mixture of two or more of them as an electrode substance is preferably used as the anode. Specific examples of such electrode substance include: metals such as Au; and conductive materials such as CuI, indium tin oxide (ITO), SnO₂, ZnO, and In—Zn—O. The anode can be formed by forming such electrode substance into a thin film by a method such as a vapor deposition method or a sputtering method. When light emitted from the above light emitting layer is extracted from the anode, the anode desirably has such property as to show a transmittance for the emitted light of more than 10%. In addition, the anode has a sheet resistance of preferably several hundreds of ohms per square or less. Further, the thickness of the anode is selected from the range of typically 10 nm to 1 μm, or preferably 10 to 200 nm, though a desired thickness varies depending on a material for the anode.

Next, as the cathode, an electrode material such as a metal, an alloy, an electroconductive compound, or a mixture of those materials, each of which has a small work function (4 eV or smaller) is used. Specific examples of the electrode material include sodium, a sodium-potassium alloy, magnesium, lithium, a magnesium-silver alloy, aluminum/aluminum oxide, Al/Li₂O, Al/LiO₂, Al/LiF, an aluminum-lithium alloy, indium, and rare earth metals.

The cathode can be prepared by forming a thin film of the electrode material described above in accordance with a process such as the vapor deposition process or the sputtering process.

When the light emitted from the light emitting layer is obtained through the cathode, it is preferable that the cathode have a transmittance of the emitted light higher than 10%. In addition, a sheet resistance of the cathode is preferably several hundreds of ohms per square or less. Further, a film thickness is generally 10 nm to 1 μm, and preferably 50 to 200 nm.

In the organic EL device of the present invention, at least one layer selected from a chalcogenide layer, a metal halide layer, and a metal oxide layer (each of which may hereinafter be referred to as “surface layer”) is preferably placed on the surface of at least one electrode in the pair of electrodes thus produced. To be specific, the following procedure is desirably adopted: a chalcogenide layer (an oxide layer is also permitted) of a metal such as silicon or aluminum is placed on the surface of the anode on the side of the light emitting layer, and a metal halide layer or a metal oxide layer is placed on the surface of the cathode on the side of the light emitting layer. With such procedure, the driving of the device can be stabilized.

Preferable examples of the above chalcogenide include SiOₓ (1≦x≦2), AlO_{X} (1≦x≦1.5), SiON, and SiAlON. Preferable examples of the metal halide include LiF, MgF₂, CaF₂, and a fluorinated rare earth metal. Preferable examples of the metal oxide include Cs₂O, Li₂O, MgO, SrO, BaO, and CaO.

In the organic EL device of the present invention, both the electron transporting property and hole transporting property of the light emitting layer are improved depending on a usage ratio between the component (A) and the component (B), whereby the intermediate layers such as the hole injecting layer, the hole transporting layer, and the electron injecting layer can be omitted. The surface layer can be, and is preferably, provided even in this case.

Further, in the organic EL device of the present invention, a mixed region of an electron transferring compound and a reducing dopant, or a mixed region of a hole transferring compound and an oxidizing dopant is preferably placed on the surface of at least one electrode in the pair of electrodes thus produced. With such procedure, the electron transferring compound is reduced to be an anion, so the ease with which the mixing region injects and transfers an electron to the light emitting layer is improved; alternatively, the hole transferring compound is oxidized to be a cation, so the ease with which the mixing region injects and transfers a hole to the light emitting layer is improved. Preferable examples of the oxidizing dopant include various Lewis acids and acceptor compounds. Preferable examples of the reducing dopant include an alkali metal, an alkali metal compound, and an alkaline earth metal, a rare earth metal, and compounds of these metals.

The light emitting layer of the organic EL device of the present invention has the following functions.

(i) The injecting function; the function of injecting holes from the anode or the hole injecting layer and injecting electrons from the cathode or the electron injecting layer when an electric field is applied.

(ii) The transporting function: the function of transporting injected charges (i.e., electrons and holes) by the force of the electric field.

(iii) The light emitting function: the function of providing the field for recombination of electrons and holes and leading to the emission of light.

A known method such as a vapor deposition method, a spin coating method, or an LB method is applicable to the formation of the light emitting layer. The light emitting layer is particularly preferably a molecular deposit film. The term “molecular deposit film” as used herein refers to a thin film formed by the deposition of a material compound in a vapor phase state, or a film formed by the solidification of a material compound in a solution state or a liquid phase state. The molecular deposit film can be typically distinguished from a thin film formed by the LB method (molecular accumulation film) on the basis of differences between the films in aggregation structure and higher order structure, and functional differences between the films caused by the foregoing differences.

In addition, as disclosed in Japanese Patent Application Laid-open No. Sho 57-51781, the light emitting layer can also be formed by: dissolving a binder such as a resin and a material compound in a solvent to prepare a solution; and forming a thin film from the prepared solution by the spin coating method or the like.

In the present invention, where desired, the light emitting layer may include other known light emitting materials other than the (A) component or (B) component, or a light emitting layer including another known light emitting material may be laminated on the light emitting layer including the light emitting material according to the present invention as long as the object of the present invention is not adversely affected.

Next, the hole injecting and transporting layer is a layer which helps injection of holes into the light emitting layer and transports the holes to the light emitting region. The layer exhibits a great mobility of holes and, in general, has an ionization energy as small as 5.5 eV or smaller. For such the hole injecting and transporting layer, a material which transports holes to the light emitting layer under an electric field of a smaller strength is preferable. A material which exhibits, for example, a mobility of holes of at least 10⁻⁶ cm²/V·sec under application of an electric field of 10⁴ to 10⁶ V/cm is preferable. The material can be arbitrarily selected from materials which are conventionally used as the hole transporting material in photoconductive materials and known materials which are used for the hole injecting layer in organic EL devices.

The hole injecting and transporting layer can be formed by forming a thin layer in accordance with a known process such as the vacuum vapor deposition process, the spin coating process, the casting process, and the LB process. In this case, the thickness of the hole injecting and transporting layer is not particularly limited. In general, the thickness is 5 nm to 5 μm.

Next, the electron injecting and transporting layer is a layer which helps injection of electrons into the light emitting layer, transports the holes to the light emitting region, and exhibits a great mobility of electrons. The adhesion improving layer is an electron injecting layer including a material exhibiting particularly improved adhesion with the cathode.

A material to be used in at least one of the electron transporting layer and the electron injecting layer is preferably an aromatic hydrocarbon compound represented by the following general formula (10) or (11).

A¹-B¹ (10)

(In the general formula (10), A¹ represents a substituted or unsubstituted aromatic hydrocarbon ring residue having three or more carbon rings, and B¹ represents a substituted or unsubstituted heterocyclic group.)

X²-(Y²)ᵣ (11)

(In the general formula (11), X² represents a substituted or unsubstituted aromatic hydrocarbon ring residue having four or more carbon rings, Y² represents a substituted or unsubstituted aryl group having 5 to 60 ring carbon atoms, a substituted or unsubstituted diarylamino group having 10 to 120 ring carbon atoms, a substituted or unsubstituted aralkyl group having 5 to 60 ring carbon atoms, or a substituted or unsubstituted alkyl group having 1 to 50 carbon atoms, r represents an integer of 1 to 6, and, when r represents 2 or more, Y²s may be identical to or different from each other.)

Examples of each of the groups Ar⁵, Ar⁶, and R²¹ to R³⁰ include examples similar to those listed in the general formula (5).

Examples of the aromatic hydrocarbon ring residue represented by A¹ in the general formula (10) include groups each having one or more kinds of anthracene, phenanthrene, naphthacene, pyrene, chrysene, benzoanthracene, pentacene, dibenzoanthracene, benzopyrene, fluorene, benzofluorene, fluoranthene, benzofluoranthene, naphthofluoranthene, dibenzofluorene, dibenzopyrene, and dibenzofluoranthene skeletons.

Examples of the heterocyclic group represented by B¹ in the general formula (10) include examples similar to those listed in the general formulae (1) and (2) in addition to, for example, pyrrolidine and imidazolidine.

Examples of the aromatic hydrocarbon ring residue represented by X² in the general formula (11) includes groups each having one or more kinds of naphthacene, pyrene, benzoanthracene, pentacene, dibenzoanthracene, benzopyrene, benzofluorene, fluoranthene, benzofluoranthene, naphthylfluoranthene, dibenzofluorene, dibenzopyrene, dibenzofluoranthene, and acenaphthylfluoranthene skeletons.

Examples of each of group represented by Y² in the general formula (11) include examples similar to those listed in the general formula (5).

In particular, the electron transporting layer and/or the electron injecting layer each preferably contain/contains at least one kind of a heterocyclic compound having, in any one of its molecules, one or more of anthracene, phenanthrene, naphthacene, pyrene, chrysene, benzoanthracene, pentacene, dibenzoanthracene, benzopyrene, fluorene, benzofluorene, fluoranthene, benzofluoranthene, naphthofluoranthene, dibenzofluorene, dibenzopyrene, and dibenzofluoranthene skeletons.

In addition, the electron transporting layer and/or the electron injecting layer each preferably contain/contains a nitrogen-containing heterocyclic compound and a nitrogen-containing heterocyclic compound having, in any one of its molecules, one or more of pyridine, pyrimidine, pyrazine, pyridazine, triazine, quinoline, quinoxaline, acridine, imidazopyridine, imidazopyrimidine, and phenanthroline skeletons is preferable.

Of those, a benzimidazole derivative represented by the following general formula (12) is preferable.

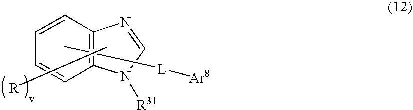

[In the general formula (12), R represents a hydrogen atom, an aryl group which has 6 to 60 carbon atoms and which may have a substituent, a pyridyl group which may have a substituent, a quinolyl group which may have a substituent, an alkyl group which has 1 to 20 carbon atoms and which may have a substituent, or an alkoxy group which has 1 to 20 carbon atoms and which may have a substituent, and v represents an integer of 0 to 4;

R³¹ represents an aryl group which has 6 to 60 ring carbon atoms and which may have a substituent, a pyridyl group which may have a substituent, a quinolyl group which may have a substituent, an alkyl group which has 1 to 20 carbon atoms and which may have a substituent, or an alkoxy group having 1 to 20 carbon atoms;

L represents an arylene group which has 6 to 60 carbon atoms and which may have a substituent, a pyridinylene group which may have a substituent, a quinolinylene group which may have a substituent, or a fluorenylene group which may have a substituent; and

Ar⁸ represents an aryl group which has 6 to 60 carbon atoms and which may have a substituent, a pyridinyl group which may have a substituent, or a quinolinyl group which may have a substituent.]

Examples of each of the groups R, R³¹, L, and Ar⁸ in the general formula (12) include examples similar to those listed in the general formula (5), and examples obtained by making the above examples divalent.

The benzimidazole derivative represented by the general formula (12) is particularly preferably of a structure represented by a general formula (13).

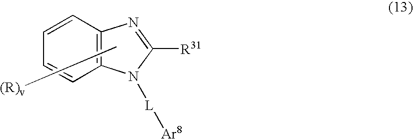

Examples of the substituents in the general formulae (10) to (12) include a substituted or unsubstituted aromatic hydrocarbon group having 6 to 50 ring carbon atoms, a substituted or unsubstituted aromatic heterocyclic group having 5 to 50 ring atoms, a substituted or unsubstituted alkyl group having 1 to 50 carbon atoms, a substituted or unsubstituted cycloalkyl group having 3 to 50 ring carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 ring atoms, a substituted or unsubstituted arylthio group having 5 to 50 ring atoms, a substituted or unsubstituted alkoxycarbonyl group having 1 to 50 carbon atoms, a substituted or unsubstituted silyl group, a carboxyl group, a halogen atom, a cyano group, a nitro group, and a hydroxyl group.

Further, defects in pixels tend to be formed in the organic EL device of the present invention due to leak and short circuit since an electric field is applied to ultra-thin films. In order to prevent the formation of the defects, a layer of a thin film having an insulating property may be inserted between the pair of electrodes.

Examples of the material used for the insulating layer include aluminum oxide, lithium fluoride, lithium oxide, cesium fluoride, cesium oxide, magnesium oxide, magnesium fluoride, calcium oxide, calcium fluoride, aluminum nitride, titanium oxide, silicon oxide, germanium oxide, silicon nitride, boron nitride, molybdenum oxide, ruthenium oxide, and vanadium oxide. Mixtures and laminates of the above-mentioned compounds may also be used.

Next, in a method of producing the organic EL device, for example, the anode and the light emitting layer, and, where necessary, the hole injecting layer and the electron injecting layer are formed in accordance with the above process and the above materials, and the cathode is formed in the last step. The organic EL device may also be prepared by forming the above-mentioned layers in the order reverse to the order described above, i.e., the cathode being formed in the first step and the anode in the last step.

Hereinafter, an example of the process for preparing an organic EL device having a construction in which an anode, a hole injecting layer, a light emitting layer, an electron injecting layer, and a cathode are disposed successively on a light-transmissive substrate will be described.

On a suitable light-transmissive substrate, a thin film made of a material for the anode is formed in accordance with the vapor deposition process or the sputtering process so that the thickness of the formed thin film is 1 μm or smaller and preferably in the range of 10 to 200 nm. The formed thin film is used as the anode. Then, a hole injecting layer is formed on the anode. The hole injecting layer can be formed in accordance with the vacuum vapor deposition process, the spin coating process, the casting process, or the LB process, as described above. The vacuum vapor deposition process is preferable since a uniform film can be easily obtained and the possibility of formation of pin holes is small. When the hole injecting layer is formed in accordance with the vacuum vapor deposition process, in general, it is preferable that the conditions be suitably selected in the following ranges: the temperature of the source of the deposition: 50 to 450° C.; the vacuum: 10⁻⁷ to 10⁻³ torr; the rate of deposition: 0.01 to 50 nm/second; the temperature of the substrate: −50 to 300° C.; and the thickness of the film: 5 nm to 5 μm although the conditions of the vacuum vapor deposition are different depending on the compound to be used (i.e., material for the hole injecting layer) and the crystal structure and the recombination structure of the target hole injecting layer.

Then, the light emitting layer is formed on the hole injecting layer formed above. The thin film can be formed by using a material formed of (A) component compound and (B) component compound according to the present invention in accordance with a process such as the vacuum vapor deposition process, the sputtering process, the spin coating process, or the casting process, and the formed thin film is used as the light emitting layer. The vacuum vapor deposition process is preferable since a uniform film can be easily obtained and the possibility of formation of pin holes is small. When the light emitting layer is formed in accordance with the vacuum vapor deposition process, in general, the conditions of the vacuum vapor deposition process can be selected in the same ranges as the conditions described for the vacuum vapor deposition of the hole injecting layer, although the conditions are different depending on the compound to be used. The film thickness is preferably within the range of 10 to 40 nm.

Next, an electron injecting layer is formed on the light emitting layer formed above. In this case, similarly to the hole injecting layer and the light emitting layer, it is preferable that the electron injecting layer be formed in accordance with the vacuum vapor deposition process since a uniform film must be obtained. The conditions of the vacuum vapor deposition can be selected in the same ranges as the condition described for the vacuum vapor deposition of the hole injecting layer and the light emitting layer.

Then, a cathode is laminated in the last step, and an organic EL device can be obtained. The cathode is formed of a metal and can be formed in accordance with the vacuum vapor deposition process or the sputtering process. It is preferable that the vacuum vapor deposition process be used in order to prevent formation of damages on the lower organic layers during the formation of the film.

In the above-mentioned preparation of the organic EL device, it is preferable that the above-mentioned layers from the anode to the cathode be formed successively while the preparation system is kept in a vacuum after being evacuated once.

The organic EL device emits light when a direct voltage of 3 to 40 V is applied in the condition that the polarity of the anode is positive (+) and the polarity of the cathode is negative (−). When the polarity is reversed, no electric current is observed and no light is emitted at all. When an alternating voltage is applied to the organic EL device, the uniform light emission is observed only in the condition that the polarity of the anode is positive and the polarity of the cathode is negative. When an alternating voltage is applied to the organic EL device, any type of wave shape can be used.

### EXAMPLES

Hereinafter, the present invention will be described in more detail on the basis of examples.

### Example 1

A transparent electrode formed of an indium tin oxide and having a thickness of 120 nm was provided on a glass substrate measuring 25 mm by 75 mm by 0.7 mm. After the glass substrate was cleaned with ultrasonic cleaning in isopropylalcohol for 5 minutes, it was washed with UV ozone for 30 minutes, and was then placed in a vacuum vapor deposition device.

First, on the substrate, N,N′-bis[4-(diphenylamino)phenyl]-N,N′-diphenyl-4,4′-benzidine was deposited from the vapor to a serve as a hole injecting layer having a thickness of 60 nm. After that, N,N,N′,N′-tetrakis(4-biphenyl)-4,4′-benzidine was deposited from the vapor onto the layer to serve as a hole transporting layer having a thickness of 10 nm. Next, as the host material, Compound (A-1) described below, which is a naphthacene derivative, and as a dopant, Compound (B-1) described below, which is a perylene derivative, were simultaneously deposited from the vapor at a weight ratio of 40:0.4 to form a light emitting layer having a thickness of 40 nm.

Next, the following Compound (C-1) was deposited from the vapor to serve as an electron transporting layer having a thickness of 30 nm.

Next, lithium fluoride was deposited from the vapor to have a thickness of 0.3 nm, and then aluminum was deposited from the vapor to have a thickness of 150 nm. The aluminum/lithium fluoride composite layer functions as a cathode. Thus, an organic EL device was produced.

The resultant organic EL device was subjected to a current test, where the device emitted red light having a current density of 10 mA/cm², a driving voltage of 4.1 V, an emission luminance of 1,135 cd/m², a chromaticity coordinate of (0.66, 0.32), and an efficiency of 11.07 cd/A. In addition, the device was subjected to a DC continuous current test with its initial luminance set to 5,000 cd/m². As a result, the driving time was 2,010 hours when the initial luminance was at 80%.

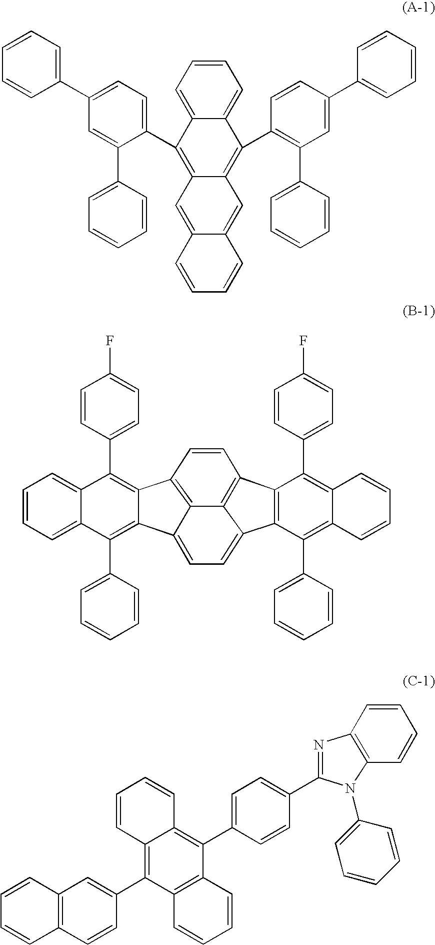

### Examples 2 to 4

Organic EL devices were each produced in the same manner as in Example 1 except that any one of Compounds (B-2) to (B-4) shown below was used instead of Compound (B-1) as a dopant, and the devices were each evaluated in the same manner as in Example 1. Table 1 shows the results.

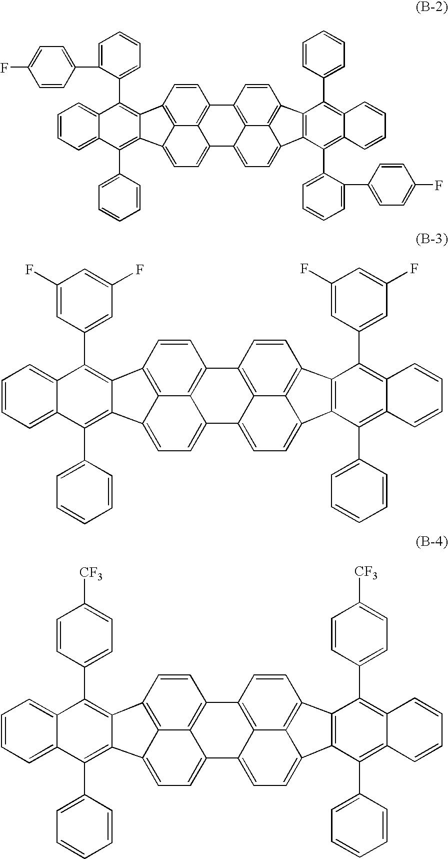

### Examples 5 to 9

Organic EL devices were each produced in the same manner as in Example 1 except that any one of Compounds (A-2) to (A-6) shown below was used instead of Compound (A-1) as a host material, and the devices were each evaluated in the same manner as in Example 1. Table 1 shows the results.

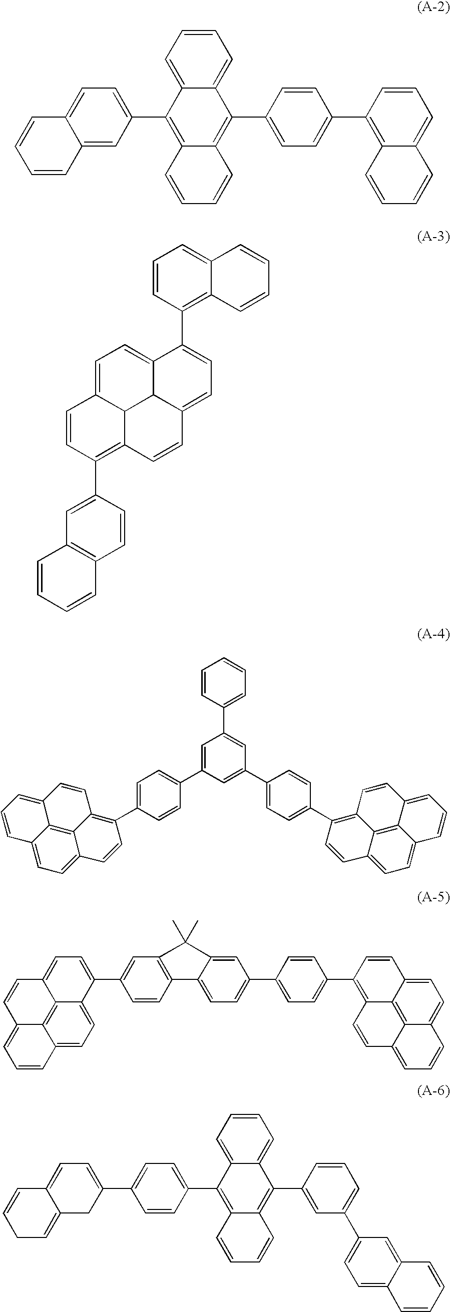

### Comparative Example 1

An organic EL device was produced in the same manner as in Example 1 except that: Compound (b-1) shown below was used instead of Compound (B-1) as a dopant; and Alq₃ shown below was used as an electron transporting material for the electron transporting layer, and the device was evaluated in the same manner as in Example 1. Table 1 shows the results.

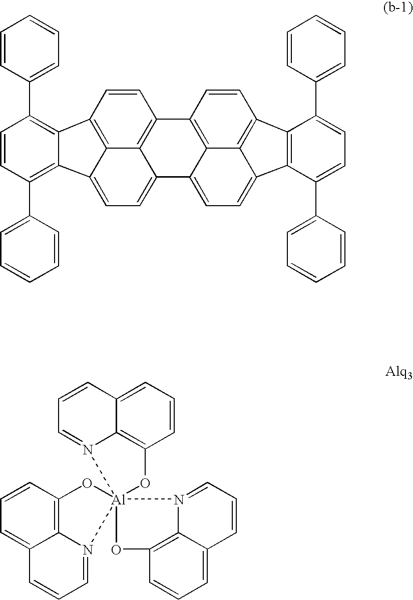

### Comparative Example 2

An organic EL device was produced in the same manner as in Example 1 except that any Compound (a-1) shown below was used instead of Compound (A-1) as a host material, and the device was each evaluated in the same manner as in Example 1. Table 1 shows the results.

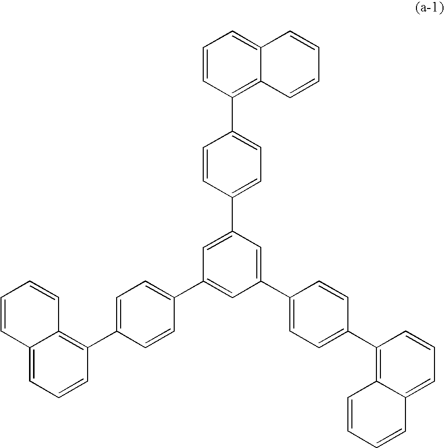

TABLE 1

| | | | | Voltage at | | | |
|---|---|---|---|---|---|---|---|
| | | | | which | | | |
| | | | Electron | device is | Current | | 80% |
| | Host | | transporting | driven | efficiency | Chromaticity | lifetime |
| | material | Dopant | material | (V) | (cd/A) | (x, y) | (hours) |
| Example 1 | A-1 | B-1 | C-1 | 4.1 | 11.4 | (0.67, 0.33) | 2,300 |
| Example 2 | A-1 | B-2 | C-1 | 4.1 | 11.3 | (0.67, 0.32) | 2,100 |
| Example 3 | A-1 | B-3 | C-1 | 4.2 | 10.98 | (0.66, 0.33) | 2,000 |
| Example 4 | A-1 | B-4 | C-1 | 4.3 | 11.2 | (0.67, 0.34) | 1,950 |
| Example 5 | A-2 | B-1 | C-1 | 4.7 | 9.16 | (0.65, 0.33) | 1,350 |
| Example 6 | A-3 | B-1 | C-1 | 4.9 | 8.01 | (0.67, 0.33) | 1,170 |
| Example 7 | A-4 | B-1 | C-1 | 4.8 | 8.35 | (0.67, 0.33) | 1,410 |
| Example 8 | A-5 | B-1 | C-1 | 4.2 | 8.16 | (0.65, 0.33) | 1,510 |
| Example 9 | A-6 | B-1 | C-1 | 4.4 | 8.22 | (0.65, 0.33) | 1,230 |
| Comparative | A-1 | b-1 | Alq3 | 5.1 | 7.67 | (0.62, 0.38) | 360 |
| Example 1 | | | | | | | |
| Comparative | a-1 | B-1 | Alq3 | 6.4 | 3.40 | (0.58, 0.38) | 90 |
| Example 2 | | | | | | | |

### INDUSTRIAL APPLICABILITY

As described above in detail, the organic EL device of the present invention has high luminous efficiency and a long lifetime, and is capable of emitting light having a color range of from an orange color to a red color. Accordingly, the device is useful as a practical organic EL device, and is suitable particularly for a full-color display.

1. An organic electroluminescence device comprising an organic thin film layer formed of one or a plurality of layers including at least a light emitting layer, the organic thin film layer being interposed between a cathode and an anode, wherein at least one layer of the organic thin film layer contains (A) a perylene compound having at least one halogen atom in any one of molecules and (B) a compound having a fused aromatic ring having 12 to 50 ring carbon atoms.

2. An organic electroluminescence device according to claim 1, wherein the perylene compound as the component (A) comprises a compound represented by the following general formula (1) and/or the following general formula (2): 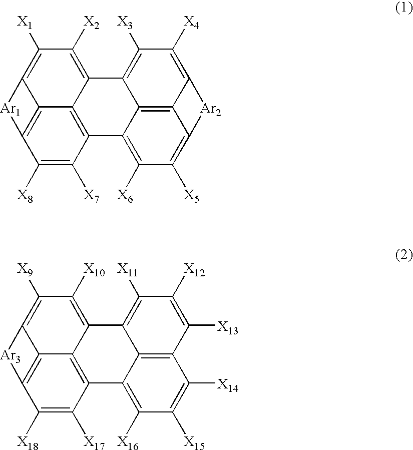
where:
Ar₁, Ar₂, and Ar₃ each independently represent a substituted or unsubstituted aromatic hydrocarbon group having 6 to 50 ring carbon atoms, or a substituted or unsubstituted aromatic heterocyclic group having 6 to 50 ring atoms; and
X₁ to X₁₈ each independently represent a group selected from a hydrogen atom, a halogen atom, a substituted or unsubstituted alkyl group having 1 to 50 carbon atoms, a substituted or unsubstituted alkoxy group having 1 to 50 carbon atoms, a substituted or unsubstituted alkylthio group having 1 to 50 carbon atoms, a substituted or unsubstituted alkenyl group having 2 to 50 carbon atoms, a substituted or unsubstituted alkenyloxy group having 1 to 50 carbon atoms, a substituted or unsubstituted alkenylthio group having 1 to 50 carbon atoms, a substituted or unsubstituted aromatic hydrocarbon group having 6 to 50 ring carbon atoms, a substituted or unsubstituted aromatic heterocyclic group having 6 to 50 ring atoms, a substituted or unsubstituted aryloxy group having 6 to 50 ring carbon atoms, a substituted or unsubstituted arylthio group having 6 to 50 ring carbon atoms, a substituted or unsubstituted aralkyl group having 7 to 50 ring carbon atoms, a substituted or unsubstituted arylalkyloxy group having 6 to 50 ring carbon atoms, a substituted or unsubstituted arylalkylthio group having 6 to 50 ring carbon atoms, a substituted or unsubstituted arylalkenyl group having 6 to 50 ring carbon atoms, a substituted or unsubstituted alkenylaryl group having 6 to 50 ring carbon atoms, an amino group, a carbazolyl group, a cyano group, a hydroxyl group, —COOR₁, —COR₂, and —OCOR₃ where R₁, R₂, and R₃ each represent a hydrogen atom, a substituted or unsubstituted alkyl group having 1 to 50 carbon atoms, a substituted or unsubstituted alkenyl group having 2 to 50 carbon atoms, a substituted or unsubstituted aralkyl group having 7 to 50 ring carbon atoms, a substituted or unsubstituted aromatic hydrocarbon group having 6 to 50 ring carbon atoms, or a substituted or unsubstituted aromatic heterocyclic group having 6 to 50 ring atoms, adjacent groups of X₁ to X₁₈ may be bonded to each other, and each of X₁ to X₁₈ may form a ring with a carbon atom to which the group is bonded,
provided that at least one of substituents of Ar₁, Ar₂, and Ar₃, X₁ to X₁₈, and substituents of X₁ to X₁₈ represents a halogen atom.

3. An organic electroluminescence device according to claim 1, wherein at least one of X₁ to X₁₈ in the general formulae (1) and (2) represents a halogen atom.

4. An organic electroluminescence device according to claim 1, wherein the perylene compound as the component (A) comprises a compound containing at least one fluorine atom or trifluoromethyl group.

5. An organic electroluminescence device according to claim 2, wherein Ar₁, Ar₂, and Ar₃ in the general formulae (1) and (2) each represent a structure represented by the following general formula (3) or (4): 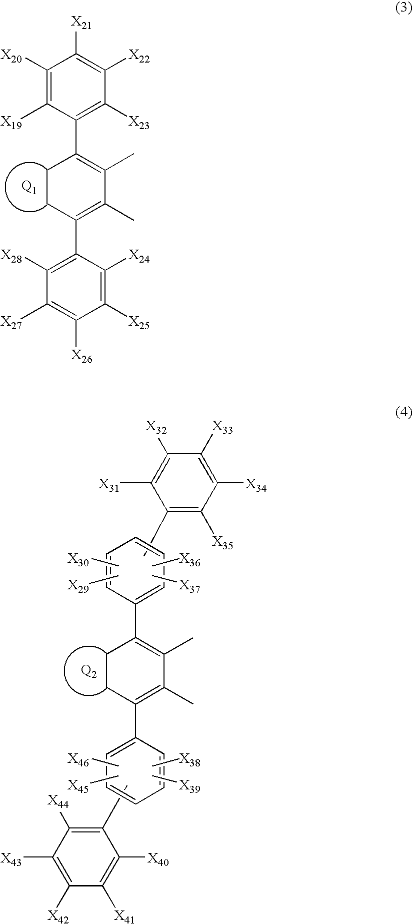
where X₁₉ to X₄₆ each have the same meaning as that of each of X₁ to X₁₈, and a ring Q₁ and a ring Q₂ each independently represent a substituted or unsubstituted aromatic hydrocarbon group having 6 to 50 ring carbon atoms, or a substituted or unsubstituted aromatic heterocyclic group having 6 to 50 ring atoms,
provided that, in the general formula (3), at least one of X₁₉ to X₂₈ represents a fluorine atom or a trifluoromethyl group, and, in the general formula (4), at least one of X₂₉ to X₄₆ represents a fluorine atom or a trifluoromethyl group.

6. An organic electroluminescence device according to claim 1, wherein the perylene compound comprises a dibenzotetraphenylperyfurantene derivative.

7. An organic electroluminescence device according to claim 1, wherein the compound having a fused aromatic ring as the component (B) comprises one or more kinds selected from a naphthacene derivative, an anthracene derivative, a benzoanthracene derivative, a dibenzoanthracene derivative, a pentacene derivative, a bisanthracene derivative, a pyrene derivative, a bispyrene derivative, a benzopyrene derivative, a dibenzopyrene derivative, a fluorene derivative, abenzofluorene derivative, adibenzofluorene derivative, a fluoranthene derivative, a benzofluoranthene derivative, a dibenzofluoranthene derivative, a naphthylfluoranthene derivative, an acenaphthylfluoranthene derivative, a diaminoanthracene derivative, a naphthofluoranthene derivative, a diaminopyrene derivative, a diaminoperylene derivative, a dibenzidine derivative, an aminoanthracene derivative, an aminopyrene derivative, and a dibenzochrysene derivative.

8. An organic electroluminescence device according to claim 1, wherein the compound having a fused aromatic ring as the component (B) comprises a naphthacene derivative represented by the following general formula (14): 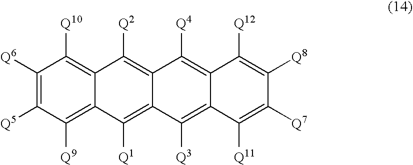
where Q¹ to Q¹² each independently represent a hydrogen atom, a substituted or unsubstituted alkyl group having 1 to 20 carbon atoms, a substituted or unsubstituted aromatic hydrocarbon group having 6 to 50 ring carbon atoms, an amino group, a substituted or unsubstituted alkoxy group having 1 to 20 carbon atoms, a substituted or unsubstituted alkylthio group having 1 to 20 carbon atoms, a substituted or unsubstituted aryloxy group having 6 to 20 ring carbon atoms, a substituted or unsubstituted arylthio group having 6 to 20 ring carbon atoms, a substituted or unsubstituted alkenyl group having 2 to 20 carbon atoms, a substituted or unsubstituted aralkyl group having 7 to 20 ring carbon atoms, or a substituted or unsubstituted aromatic heterocyclic group having 6 to 20 ring atoms, Q¹ to Q¹² may be identical to or different from one another, and adjacent groups of Q¹ to Q¹² may form a saturated or unsaturated cyclic structure.

9. An organic electroluminescence device according to claim 8, wherein at least one of Q¹, Q², Q³, and Q⁴ in the general formula (14) represents an aromatic hydrocarbon group.

10. An organic electroluminescence device according to claim 8, wherein the naphthacene derivative represented by the general formula (14) has a structure represented by the following general formula (15): 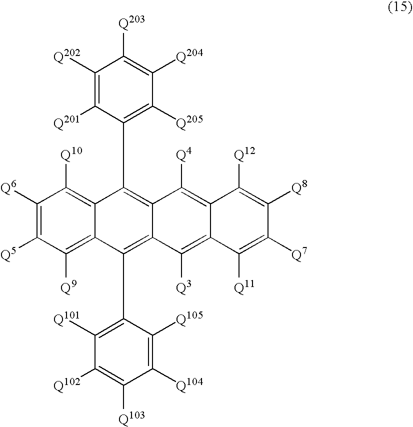
where Q³ to Q¹², Q¹⁰¹ to Q¹⁰⁵, and Q²⁰¹ to Q²⁰⁵ each independently represent the same group as that represented by any one of Q¹ to Q¹², Q³ to Q¹², Q¹⁰¹ to Q¹⁰⁵, and Q²⁰¹ to Q²⁰⁵ may be identical to or different from one another, and adjacent groups of Q³ to Q¹², Q¹⁰¹ to Q¹⁰⁵, and Q²⁰¹ to Q²⁰⁵ may form a saturated or unsaturated cyclic structure.

11. An organic electroluminescence device according to claim 10, wherein at least one of Q¹⁰¹, Q¹⁰⁵, Q²⁰¹, and Q²⁰⁵ in the general formula (15) represents a substituted or unsubstituted alkyl group having 1 to 20 carbon atoms, a substituted or unsubstituted aromatic hydrocarbon group having 6 to 50 ring carbon atoms, an amino group, a substituted or unsubstituted alkoxy group having 1 to 20 carbon atoms, a substituted or unsubstituted alkylthio group having 1 to 20 carbon atoms, a substituted or unsubstituted aryloxy group having 6 to 20 ring carbon atoms, a substituted or unsubstituted arylthio group having 6 to 20 ring carbon atoms, a substituted or unsubstituted alkenyl group having 2 to 20 carbon atoms, a substituted or unsubstituted aralkyl group having 7 to 20 ring carbon atoms, or a substituted or unsubstituted aromatic heterocyclic group having 6 to 20 ring atoms.

12. An organic electroluminescence device according to claim 1, wherein the compound having a fused aromatic ring as the component (B) comprises an anthracene derivative represented by the following general formula (5), an asymmetric anthracene derivative represented by a general formula (6), an asymmetric pyrene derivative represented by a general formula (7), an asymmetric diphenylanthracene derivative represented by a general formula (8), or a bispyrene derivative represented by a general formula (9): 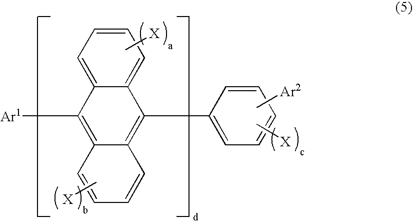
where:
X represents a hydrogen atom, a substituted or unsubstituted aromatic hydrocarbon group having 6 to 50 ring carbon atoms, a substituted or unsubstituted aromatic heterocyclic group having 5 to 50 ring carbon atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 carbon atoms, a substituted or unsubstituted arylthio group having 5 to 50 carbon atoms, a substituted or unsubstituted alkoxy carbonyl group having 1 to 50 carbon atoms, a substituted or unsubstituted silyl group, a carboxyl group, a halogen atom, a cyano group, a nitro group, or a hydroxyl group;
Ar¹ and Ar² each independently represent a substituted or unsubstituted fused aromatic group having 10 to 50 ring carbon atoms, and at least one of Ar¹ and Ar² represents a 1-naphthyl group represented by the following general formula (5-1) or a 2-naphthyl group represented by the following general formula (5-2): 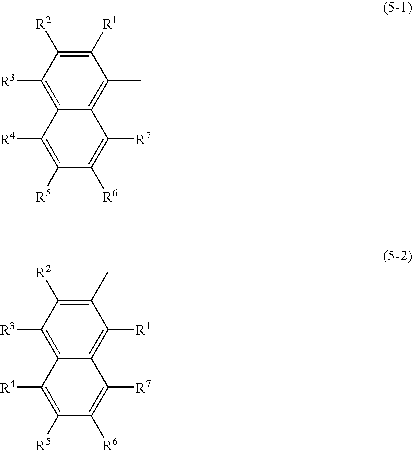
where R¹ to R⁷ each independently represent a hydrogen atom, or a substituted or unsubstituted alkyl group having 1 to 50 carbon atoms, and at least one pair of adjacent groups of R¹ to R⁷ comprises a pair of alkyl groups which are bonded to each other to form a cyclic structure; and
a, b, and c each represent an integer of 0 to 4, d represents an integer of 1 to 3, and, when d represents 2 or more, groups in [ ] may be identical to or different from each other, 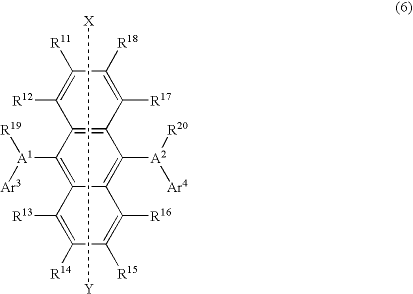
where:
A¹ and A² each independently represent a substituted or unsubstituted fused aromatic hydrocarbon group having 10 to 20 ring carbon atoms;
Ar³ and Ar⁴ each independently represent a hydrogen atom, or a substituted or unsubstituted aromatic hydrocarbon group having 6 to 50 ring carbon atoms;
R¹¹ to R²⁰ each independently represent a hydrogen atom, a substituted or unsubstituted aromatic hydrocarbon group having 6 to 50 ring carbon atoms, a substituted or unsubstituted aromatic heterocyclic group having 5 to 50 ring atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 carbon atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group, or a hydroxyl group; and
the number of each of Ar³, Ar⁴, R¹⁹, and R²⁰ may be two or more, and adjacent groups may form a saturated or unsaturated cyclic structure;
provided that there is no case where groups symmetric with respect to the X-Y axis shown on central anthracene in the general formula (6) bind to 9- and 10-positions of the anthracene. 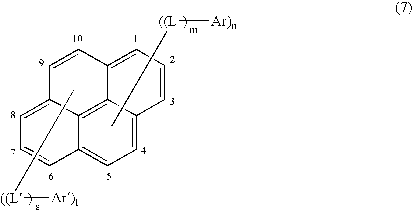
where:
Ar and Ar′ each independently represent a substituted or unsubstituted aromatic group having 6 to 50 ring carbon atoms;
L and L′ each independently represent a substituted or unsubstituted phenylene group, a substituted or unsubstituted naphthalenylene group, a substituted or unsubstituted fluorenylene group, or a substituted or unsubstituted dibenzosilolylene group;
m represents an integer of 0 to 2, n represents an integer of 1 to 4, s represents an integer of 0 to 2, and t represents an integer of 0 to 4; and
in addition, L or Ar binds to any one of 1- to 5-positions of pyrene, and L′ or Ar′ binds to any one of 6- to 10-positions of pyrene;
provided that Ar, Ar′, L, and L′ satisfy the following item (1) or (2) when n+t represents an even number,
(1) Ar≠Ar′ and/or L≠L′ (where the symbol “≠” means that groups connected with the symbol have different structures)
(2) When Ar=Ar′ and L=L′,
(2-1) m≠s and/or n≠t, or
(2-2) when m=s and n=t,
(2-2-1) L and L′ (or pyrene) bind (or binds) to different binding positions on Ar and Ar′, or
(2-2-2) in the case where L and L′ (or pyrene) bind (or binds) to the same binding positions on Ar and Ar′,
the substitution positions of L and L′, or of Ar and Ar′ in pyrene are not symmetrically related.] 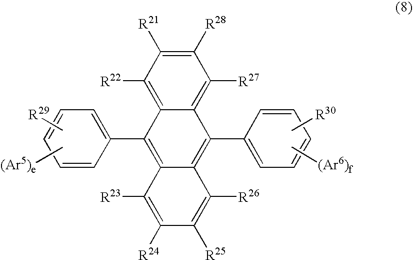
where:
Ar⁵ and Ar⁶ each independently represent a substituted or unsubstituted aromatic hydrocarbon group having 6 to 50 ring carbon atoms, e and f each represent an integer of 1 to 4, provided that Ar⁵ and Ar⁶ are not identical to each other when e=f=1 and positions at which Ar⁵ and Ar⁶ are bound to a benzene ring are bilaterally symmetric, and e and f represent different integers when e or f represents an integer of 2 to 4;
R²¹ to R²⁸ each independently represent a hydrogen atom, a substituted or unsubstituted aromatic hydrocarbon group having 6 to 50 ring carbon atoms, a substituted or unsubstituted aromatic heterocyclic group having 5 to 50 ring atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 carbon atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group, or a hydroxyl group; and
R²⁹ to R³⁰ each independently represent a hydrogen atom, a substituted or unsubstituted aromatic hydrocarbon group having 6 to 50 ring carbon atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 carbon atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group, or a hydroxyl group.
(A)ₖ-(X¹)_{g}—(Ar⁷)ₕ—(Y¹)ₚ—(B)_{q} (9)
where:
X¹ represents a substituted or unsubstituted pyrene residue;
A and B each independently represent a hydrogen atom, a substituted or unsubstituted aromatic hydrocarbon group having 3 to 50 ring carbon atoms, a substituted or unsubstituted aromatic heterocyclic group having 3 to 50 ring atoms, a substituted or unsubstituted alkyl or alkylene group having 1 to 50 carbon atoms, or a substituted or unsubstituted alkenyl or alkenylene group having 1 to 50 carbon atoms;
Ar⁷ represents a substituted or unsubstituted aromatic hydrocarbon group having 3 to 50 ring carbon atoms and/or a substituted or unsubstituted aromatic heterocyclic group having 3 to 50 ring atoms;
Y¹ represents a substituted or unsubstituted fused ring group having 5 to 50 ring carbon atoms and/or a substituted or unsubstituted fused heterocyclic group having 5 to 50 ring atoms; and
g represents an integer of 1 to 3, k and q each represent an integer of 0 to 4, p represents an integer of 0 to 3, and h represents an integer of 1 to 5.

13. An organic electroluminescence device according to claim 1, wherein the light emitting layer contains the perylene compound as the component (A) and the compound having a fused aromatic ring as the component (B).

14. An organic electroluminescence device according to claim 13, wherein the light emitting layer contains the perylene compound as a dopant at a content of 0.1 to 10 wt %.

15. An organic electroluminescence device according to claim 13, wherein the light emitting layer contains the perylene compound as a dopant at a content of 0.5 to 2 wt %.

16. An organic electroluminescence device according to claim 1, wherein the organic thin film layer has an electron transporting layer and/or an electron injecting layer, and the electron transporting layer and/or the electron injecting layer each contain/contains an aromatic hydrocarbon compound represented by the following general formula (10) or (11):
A¹-B¹ (10)
where A¹ represents a substituted or unsubstituted aromatic hydrocarbon ring residue having three or more carbon rings, and B¹ represents a substituted or unsubstituted heterocyclic group, and
X²-(Y²)ᵣ (11)
where X² represents a substituted or unsubstituted aromatic hydrocarbon ring residue having four or more carbon rings, Y² represents a substituted or unsubstituted aryl group having 5 to 60 ring carbon atoms, a substituted or unsubstituted diarylamino group having 10 to 120 ring carbon atoms, a substituted or unsubstituted aralkyl group having 5 to 60 ring carbon atoms, or a substituted or unsubstituted alkyl group having 1 to 50 carbon atoms, r represents an integer of 1 to 6, and, when r represents 2 or more, Y²s may be identical to or different from each other.

17. An organic electroluminescence device according to claim 16, wherein X² in the general formula (11) contains one or more kinds of naphthacene, pyrene, benzoanthracene, pentacene, dibenzoanthracene, benzopyrene, benzofluorene, fluoranthene, benzofluoranthene, naphthylfluoranthene, dibenzofluorene, dibenzopyrene, dibenzofluoranthene, and acenaphthylfluoranthene skeletons.

18. An organic electroluminescence device according to claim 16, wherein the electron transporting layer and/or the electron injecting layer each contain/contains at least one kind of a heterocyclic compound having, in any one of molecules, one or more of anthracene, phenanthrene, naphthacene, pyrene, chrysene, benzoanthracene, pentacene, dibenzoanthracene, benzopyrene, fluorene, benzofluorene, fluoranthene, benzofluoranthene, naphthofluoranthene, dibenzofluorene, dibenzopyrene, and dibenzofluoranthene skeletons.

19. An organic electroluminescence device according to claim 16, wherein the electron transporting layer and/or the electron injecting layer each contain/contains a nitrogen-containing heterocyclic compound.

20. An organic electroluminescence device according to claim 16, wherein the electron transporting layer and/or the electron injecting layer each contain/contains at least one kind of a nitrogen-containing heterocyclic compound having, in any one of molecules, one or more of pyridine, pyrimidine, pyrazine, pyridazine, triazine, quinoline, quinoxaline, acridine, imidazopyridine, imidazopyrimidine, and phenanthroline skeletons.

21. An organic electroluminescence device according to claim 16, wherein the electron transporting layer and/or the electron injecting layer each contain/contains a benzimidazole derivative represented by the following general formula (12): 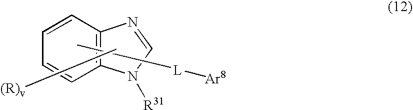
where:
R represents a hydrogen atom, an aryl group which has 6 to 60 carbon atoms and which may have a substituent, a pyridyl group which may have a substituent, a quinolyl group which may have a substituent, an alkyl group which has 1 to 20 carbon atoms and which may have a substituent, or an alkoxy group which has 1 to 20 carbon atoms and which may have a substituent, and v represents an integer of 0 to 4;
R³¹ represents an aryl group which has 6 to 60 ring carbon atoms and which may have a substituent, a pyridyl group which may have a substituent, a quinolyl group which may have a substituent, an alkyl group which has 1 to 20 carbon atoms and which may have a substituent, or an alkoxy group having 1 to 20 carbon atoms;
L represents an arylene group which has 6 to 60 carbon atoms and which may have a substituent, a pyridinylene group which may have a substituent, a quinolinylene group which may have a substituent, or a fluorenylene group which may have a substituent; and
Ar⁸ represents an aryl group which has 6 to 60 carbon atoms and which may have a substituent, a pyridinyl group which may have a substituent, or a quinolinyl group which may have a substituent.

22. An organic electroluminescence device according to claim 1, wherein a luminescent color of light emitted from the device ranges from an orange color to a red color.
